(19) United States
(12) Patent Application Publication
(10) Pub. No.: US 2023/0010426 A1
(43) Pub. Date: Jan. 12, 2023

(54) Tool Rack For Interchangeable Robot Tools

(71) Applicant: X Development LLC, Mountain View, CA (US)

(72) Inventors: Edward Coyne, San Bruno, CA (US); Miguel Rivas, San Francisco, CA (US)

(21) Appl. No.: 17/810,796

(22) Filed: Jul. 5, 2022

Related U.S. Application Data
(60) Provisional application No. 63/218,669, filed on Jul. 6, 2021.

(51) Int. Cl. B25J 15/04; G06K 7/10; H04L 67/025; G05B 19/4155

(52) U.S. Cl. CPC B25J 15/0483; G06K 7/10366; H04L 67/025; G05B 19/4155; B25J 15/0491; G05B 2219/50391

(57) ABSTRACT

A system includes a robotic device, a tool rack, a network access point, a message router, and a first tool. The tool rack includes a tool holster that provides for removable coupling of tools to the tool rack and a wireless tag that indicates a wireless network identifier of the tool rack. The network access point generates a wireless network based on the wireless network identifier. The message router communicatively connects, by way of the wireless network, the robotic device to the tools. The first tool is operable by a manipulator of the robotic device and includes an adapter configured to removably couple to the tool holster, a wireless tag reader that scans the wireless tag when the first tool is coupled to the tool holster, and a processor that connects to the wireless network and communicates with the robotic device by way of the message router.

### CROSS REFERENCE TO RELATED APPLICATIONS

This application claims priority to U.S. provisional patent application No. 63/218,669, filed on Jul. 6, 2021, which is hereby incorporated by reference as if fully set forth in this description.

### BACKGROUND

As technology advances, various types of robotic devices are being created for performing a variety of functions that may assist users. Robotic devices may be used for applications involving material handling, transportation, welding, assembly, and dispensing, among others. Over time, the manner in which these robotic systems operate is becoming more intelligent, efficient, and intuitive. As robotic systems become increasingly prevalent in numerous aspects of modern life, it is desirable for robotic systems to be efficient. Therefore, a demand for efficient robotic systems has helped open up a field of innovation in actuators, movement, sensing techniques, as well as component design and assembly.

### SUMMARY

A robotic device may be configured to use various tools to perform tasks in an environment. Usage of these tools may be facilitated by a tool rack that stores and/or maintains the tools for the robotic device. Specifically, the tool rack may include a plurality of holsters, each of which may be configured to store a tool and may be equipped with a wireless tag that identifies the holster and indicates a wireless network associated with the tool rack. The wireless network may be specific to the tool rack and may allow the tool to communicate with the robotic device, which, in some implementations, may also be connected to the wireless network at least while using the tool rack. A message router may be configured to route communications transmitted between the tool and the robotic device by way of the wireless network. The wireless network and the message router may facilitate communications between tools and the robotic device, and may also operate to identify the scope of tools that are currently available on the tool rack. Accordingly, the wireless network and the message router may assist the robotic device with differentiating tools available on the tool rack from other tools that may be present in the environment (e.g., tools on other tool racks) but that are not provided on the tool rack.

A first example embodiment may involve a system that includes a robotic device that has a manipulator. The system may also include a tool rack that includes (i) a tool holster configured to provide for removable coupling of one or more tools to the tool rack and (ii) a wireless tag configured to indicate, to the one or more tools when coupled to the tool holster, a wireless network identifier associated with the tool rack. The system may additionally include a network access point configured to generate a wireless network associated with and based on the wireless network identifier of the tool rack. The system may further include a message router associated with the tool rack and configured to communicatively connect, by way of the wireless network, the robotic device to the one or more tools. The system may yet further include a first tool operable by the manipulator of the robotic device and including (i) an adapter configured to removably couple to the tool holster, (ii) a wireless tag reader configured to scan the wireless tag when the first tool is coupled to the tool holster, and (iii) a processor configured to connect to the wireless network and communicate with the robotic device by way of the message router.

A second example embodiment may involve a method that includes providing a robotic device that has a manipulator. The method may also include providing a tool rack comprising (i) a tool holster configured to provide for removable coupling of one or more tools to the tool rack and (ii) a wireless tag configured to indicate, to the one or more tools when coupled to the tool holster, a wireless network identifier associated with the tool rack. The method may additionally include generating, by a network access point, a wireless network associated with and based on the wireless network identifier of the tool rack. The method may further include communicatively connecting, using a message router associated with the tool rack and by way of the wireless network, the robotic device to the one or more tools. The method may yet further include connecting, using a processor of a first tool, to the wireless network and communicating, using the processor, with the robotic device by way of the message router. The first tool may be operable by the manipulator of the robotic device and may include (i) an adapter configured to removably couple to the tool holster and a wireless tag reader configured to scan the wireless tag when the first tool is coupled to the tool holster.

A third example embodiment may involve a system that includes a robotic device that has a manipulator. The system may also include a tool rack that includes (i) a tool holding means configured to provide for removable coupling of one or more tools to the tool rack and (ii) a wireless indicator means configured to indicate, to the one or more tools when coupled to the tool holding means, a wireless network identifier associated with the tool rack. The system may additionally include a network access means configured to generate a wireless network associated with and based on the wireless network identifier of the tool rack. The system may further include a message routing means associated with the tool rack and configured to communicatively connect, by way of the wireless network, the robotic device to the one or more tools. The system may yet further include a first tool operable by the manipulator of the robotic device and including (i) an adapter means configured to removably couple to the tool holding means, (ii) a wireless indicator reading means configured to scan the wireless indicator means when the first tool is coupled to the tool holding means, and (iii) a processor configured to connect to the wireless network and communicate with the robotic device by way of the message routing means.

A fourth example embodiment may involve one or more non-transitory computer-readable media, having stored thereon program instructions that, upon execution by one or more computing systems, cause the one or more computing system to perform any of the operations disclosed herein, including operations in accordance with the first, second, and/or third example embodiments.

A fifth example embodiment may involve a computing system that may include at least one processor, as well as memory and program instructions. The program instructions may be stored in the memory, and upon execution by the at least one processor, cause the computing system to perform any of the operations disclosed herein, including operations in accordance with the first, second, and/or third example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a configuration of a robotic system, in accordance with example embodiments.

FIG. 2 illustrates a mobile robot, in accordance with example embodiments.

FIG. 3 illustrates an exploded view of a mobile robot, in accordance with example embodiments.

FIG. 4 illustrates a robotic arm, in accordance with example embodiments.

FIG. 5 illustrates a logical architecture of a tool rack system, in accordance with example embodiments.

FIGS. 6A, 6B, and 6C illustrate physical architectures of a tool rack system, in accordance with example embodiments.

FIGS. 7A, 7B, and 7C illustrate aspects of a physical implementation of a tool rack, a tool holster, and a tool handle, in accordance with example embodiments.

FIGS. 7D and 7E illustrate a tool rack provided on a robotic device, in accordance with example embodiments.

FIGS. 8A, 8B, and 8C illustrate a message flow diagram, in accordance with example embodiments.

FIG. 9 illustrates a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. OVERVIEW

A robotic device may be configured to use various tools to carry out various tasks. The tools may be provided on a tool rack that allows different tools to be quickly and easily retrieved from and/or returned to the tool rack by the robotic device, as well as added to and/or removed from the tool rack by a user or operator. Specifically, the tool rack may include a plurality of tool holsters each configured to hold a tool. Each holster may be positioned at a corresponding pose relative to a reference frame of the tool rack. The tool rack may include a physical configuration indicator (e.g., a wireless tag) configured to indicate, to the robotic device, the structure of the tool rack, including the number of holsters and the pose of each holster. When using the tool rack, the robotic device may be positioned at a predetermined pose relative to the tool rack due to, for example, the tool rack being mounted at a predetermined position on a base of the robotic device.

Accordingly, the robotic device may be configured to determine the pose of each holster in a reference frame of the robotic device, and may thus be able to repeatedly retrieve tools from and/or return tools to each holster based on joint positions of the robotic device, without relying on perceptual sensor data. Thus, the robotic device may be able to, while retrieving a tool from or returning a tool to a given holster, collect perceptual data that does not represent the tool rack, holsters, and/or tools and that may be related to a task different from tool retrieval and/or tool replacement. That is, by providing tools at predetermined poses, the tool rack may allow the robotic device to use the perception systems thereof to perform another task in parallel with tool retrieval and/or tool replacement.

Each respective holster of the plurality of holsters may include a connector configured to removably connect to an adapter provided as part of each tool. The same or similar connector structure may be shared by the plurality of holsters, and the same or similar adapter structure may be shared by a plurality of tools, thus allowing each respective holster to removably couple to each of the tools. Additionally, each respective holster of the plurality of holsters may include a wireless tag configured to be read by a wireless tag reader provided as part of each tool. The wireless tag may be configured to identify the respective holster in which the tool is placed, thus allowing the tool to indicate its position to the robotic device, and identify a wireless network associated with the tool rack, thus allowing the tool to communicate with other components associated with the tool rack.

Specifically, rather than relying on a wired connection between the tool rack and the tool and/or between the robotic device and the tool, communications between the tools and the robotic device may be transmitted by way of the wireless network associated with the tool rack. The wireless network may be specific and/or unique to the tool rack, with different tool racks being associated with different wireless networks having corresponding different wireless network identifiers. Accordingly, in addition to providing a communication medium, the wireless network may also operate to define a scope of the devices, including tools and robotic devices, that are using a particular tool rack. Thus, the tool rack-specific wireless network may allow a robotic device to target its communications to tools on the specific tool rack that the robotic device is currently using, thereby avoiding inadvertently communicating with other tools on other tool racks that are not available to the robotic device. Similarly, the tool rack-specific wireless network may allow a tool to target its communications to the robotic device using the specific tool rack on which the tool is disposed, thereby avoiding inadvertently communicating with other robotic devices that are using other tool racks. In some implementations, the robotic device may be configured to identify and connect to the tool rack-specific wireless network based on scanning of a wireless network indicator (e.g., a wireless tag) provided as part of the tool rack.

Communications between the tools and the robotic device may be further facilitated by a message router, which may also be specific and/or unique to the tool rack. The message router of a given tool rack may be accessible by way of the wireless network associated with the given tool rack, but might not be accessible by way of other wireless networks of other tool racks. For example, the message router may be addressable by the robotic device and/or tools using a predetermined network address, which may be shared across different tool racks or which may be different for different tool racks and thus indicated to the robotic device and/or tools using, for example, wireless tags on the different tool racks. The message router may be configured to maintain a subscription policy for each tool and each robotic device connected to the corresponding wireless network. Specifically, the message router may subscribe each tool to communications from the robotic device, and may subscribe the robotic device to transmissions from each of the tools, but might not subscribe each tool to transmissions from other tools. Thus, the message router may allow each tool to operate independently of other tools while also allowing each tool to communicate with the robotic device.

Using the components provided in connection with the tool rack, the robotic device and each of the tools may be configured to automatically identify the tool rack, connect to the corresponding wireless network, and communicate by way of the corresponding message router. Thus, a user or operator may be able to swap tools on the tool rack by physically placing a new tool on the tool rack. Aside from physical placement of the new tool on the tool rack, the user or operator might not need to take additional steps to cause the robotic device to recognize and/or use the new tool, since each tool may be able to self-configure for the new tool rack to which it has been added using the wireless tag(s) thereon. Similarly, the user or operator may equip a robotic device with a new tool rack by physically mounting the new tool rack on the robotic device, and the robotic device may be able to self-configure for the new tool rack using, for example, wireless tag(s) thereon.

After connecting to the tool rack-specific wireless network, a given tool may be configured to transmit, to the message router and by way of the wireless network, an indication that the tool is available in a corresponding holster on the tool rack and an indication of one or more attributes of the given tool. In accordance with the subscription policy, the message router may be configured to forward these indications to the robotic device, thus informing the robotic device of the tool's availability, position, and/or capabilities. The robotic device may be configured to consider tools that have transmitted, within a predetermined preceding period of time, an indication of availability to be active, and may consider all other tools to be inactive and thus unavailable. Accordingly, each tool may be configured to periodically transmit a new indication of its availability on the tool rack, thereby indicating that the tool is available and/or has not malfunctioned. This approach may allow the robotic device to avoid attempting to use tools that have malfunctioned and/or have been removed from the tool rack.

Similarly, after the robotic device retrieves the given tool to be used in connection with performance of a corresponding task, the robotic device may be configured to periodically reactivate the given tool by transmitting thereto an appropriate command by way of the message router and the wireless network. Specifically, the given tool may allow the robotic device to activate the given tool for a particular period of time, but might not allow itself to be activated for an indefinite period of time (e.g., might not provide an “on” command that does not include a time limit). The given tool may be configured to automatically deactivate after the particular period of time, without depending on an explicit command from the robotic device. This may reduce the frequency with which tools are inadvertently left on.

Additionally, the robotic device may be configured to perform the corresponding task while the given tool confirms that it is active, and may be configured to stop performing the task if a confirmation that the task is active has not been received for over a threshold period of time. This may reduce the frequency with which a robotic device attempts to use a tool that, unbeknownst to the robotic device, is actually inactive, and thus does not actually assist in successful performance of the task.

### II. EXAMPLE ROBOTIC DEVICES AND SYSTEMS

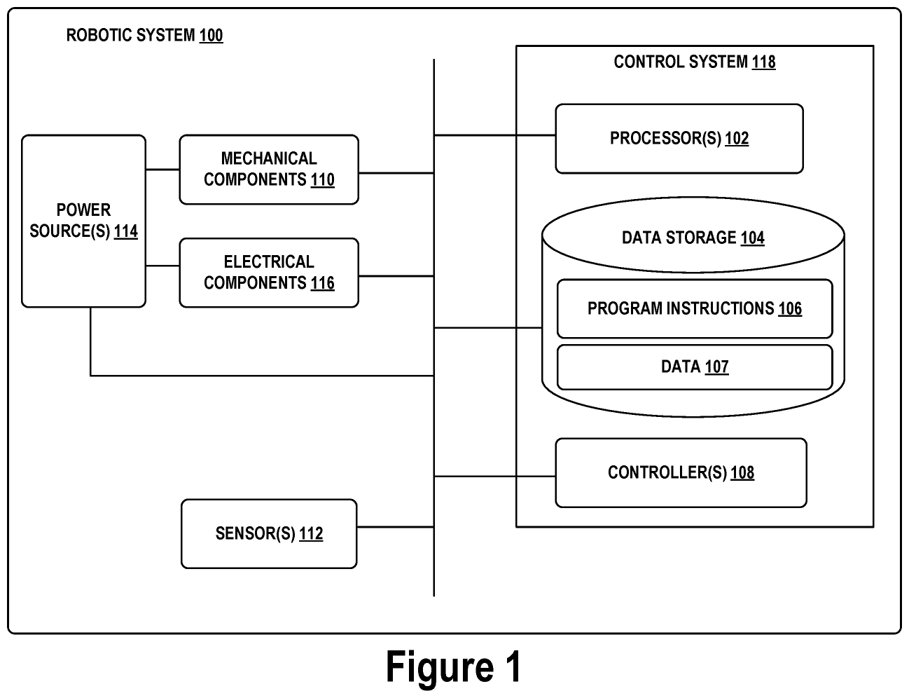

FIG. 1 illustrates an example configuration of a robotic system that may be used in connection with the implementations described herein. Robotic system 100 may be configured to operate autonomously, semi-autonomously, or using directions provided by user(s). Robotic system 100 may be implemented in various forms, such as a robotic arm, industrial robot, or some other arrangement. Some example implementations involve a robotic system 100 engineered to be low cost at scale and designed to support a variety of tasks. Robotic system 100 may be designed to be capable of operating around people. Robotic system 100 may also be optimized for machine learning. Throughout this description, robotic system 100 may also be referred to as a robot, robotic device, and/or mobile robot, among other designations.

As shown in FIG. 1, robotic system 100 may include processor(s) 102, data storage 104, and controller(s) 108, which together may be part of control system 118. Robotic system 100 may also include sensor(s) 112, power source(s) 114, mechanical components 110, and electrical components 116. Nonetheless, robotic system 100 is shown for illustrative purposes, and may include more or fewer components. The various components of robotic system 100 may be connected in any manner, including by way of wired or wireless connections. Further, in some examples, components of robotic system 100 may be distributed among multiple physical entities rather than a single physical entity. Other example illustrations of robotic system 100 may exist as well.

Processor(s) 102 may operate as one or more general-purpose hardware processors or special purpose hardware processors (e.g., digital signal processors, application specific integrated circuits, etc.). Processor(s) 102 may be configured to execute computer-readable program instructions 106 and manipulate data 107, both of which are stored in data storage 104. Processor(s) 102 may also directly or indirectly interact with other components of robotic system 100, such as sensor(s) 112, power source(s) 114, mechanical components 110, or electrical components 116.

Data storage 104 may be one or more types of hardware memory. For example, data storage 104 may include or take the form of one or more computer-readable storage media that can be read or accessed by processor(s) 102. The one or more computer-readable storage media can include volatile and/or non-volatile storage components, such as optical, magnetic, organic, or another type of memory or storage, which can be integrated in whole or in part with processor(s) 102. In some implementations, data storage 104 can be a single physical device. In other implementations, data storage 104 can be implemented using two or more physical devices, which may communicate with one another via wired or wireless communication. As noted previously, data storage 104 may include the computer-readable program instructions 106 and data 107. Data 107 may be any type of data, such as configuration data, sensor data, or diagnostic data, among other possibilities.

Controller 108 may include one or more electrical circuits, units of digital logic, computer chips, or microprocessors that are configured to (perhaps among other tasks), interface between any combination of mechanical components 110, sensor(s) 112, power source(s) 114, electrical components 116, control system 118, or a user of robotic system 100. In some implementations, controller 108 may be a purpose-built embedded device for performing specific operations with one or more subsystems of robotic system 100.

Control system 118 may monitor and physically change the operating conditions of robotic system 100. In doing so, control system 118 may serve as a link between portions of robotic system 100, such as between mechanical components 110 or electrical components 116. In some instances, control system 118 may serve as an interface between robotic system 100 and another computing device. Further, control system 118 may serve as an interface between robotic system 100 and a user. In some instances, control system 118 may include various components for communicating with robotic system 100, including a joystick, buttons, or ports, etc. The example interfaces and communications noted above may be implemented via a wired or wireless connection, or both. Control system 118 may perform other operations for robotic system 100 as well.

During operation, control system 118 may communicate with other systems of robotic system 100 via wired and/or wireless connections, and may further be configured to communicate with one or more users of the robot. As one possible illustration, control system 118 may receive an input (e.g., from a user or from another robot) indicating an instruction to perform a requested task, such as to pick up and move an object from one location to another location. Based on this input, control system 118 may perform operations to cause the robotic system 100 to make a sequence of movements to perform the requested task. As another illustration, a control system may receive an input indicating an instruction to move to a requested location. In response, control system 118 (perhaps with the assistance of other components or systems) may determine a direction and speed to move robotic system 100 through an environment en route to the requested location.

Operations of control system 118 may be carried out by processor(s) 102. Alternatively, these operations may be carried out by controller(s) 108, or a combination of processor(s) 102 and controller(s) 108. In some implementations, control system 118 may partially or wholly reside on a device other than robotic system 100, and therefore may at least in part control robotic system 100 remotely.

Mechanical components 110 represent hardware of robotic system 100 that may enable robotic system 100 to perform physical operations. As a few examples, robotic system 100 may include one or more physical members, such as an arm, an end effector, a head, a neck, a torso, a base, and wheels. The physical members or other parts of robotic system 100 may further include actuators arranged to move the physical members in relation to one another. Robotic system 100 may also include one or more structured bodies for housing control system 118 or other components, and may further include other types of mechanical components. The particular mechanical components 110 used in a given robot may vary based on the design of the robot, and may also be based on the operations or tasks the robot may be configured to perform.

In some examples, mechanical components 110 may include one or more removable components. Robotic system 100 may be configured to add or remove such removable components, which may involve assistance from a user or another robot. For example, robotic system 100 may be configured with removable end effectors or digits that can be replaced or changed as needed or desired. In some implementations, robotic system 100 may include one or more removable or replaceable battery units, control systems, power systems, bumpers, or sensors. Other types of removable components may be included within some implementations.

Robotic system 100 may include sensor(s) 112 arranged to sense aspects of robotic system 100. Sensor(s) 112 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, or cameras, among other possibilities. Within some examples, robotic system 100 may be configured to receive sensor data from sensors that are physically separated from the robot (e.g., sensors that are positioned on other robots or located within the environment in which the robot is operating).

Sensor(s) 112 may provide sensor data to processor(s) 102 (perhaps by way of data 107) to allow for interaction of robotic system 100 with its environment, as well as monitoring of the operation of robotic system 100. The sensor data may be used in evaluation of various factors for activation, movement, and deactivation of mechanical components 110 and electrical components 116 by control system 118. For example, sensor(s) 112 may capture data corresponding to the terrain of the environment or location of nearby objects, which may assist with environment recognition and navigation.

In some examples, sensor(s) 112 may include RADAR (e.g., for long-range object detection, distance determination, or speed determination), LIDAR (e.g., for short-range object detection, distance determination, or speed determination), SONAR (e.g., for underwater object detection, distance determination, or speed determination), VICON® (e.g., for motion capture), one or more cameras (e.g., stereoscopic cameras for 3D vision), a global positioning system (GPS) transceiver, or other sensors for capturing information of the environment in which robotic system 100 is operating. Sensor(s) 112 may monitor the environment in real time, and detect obstacles, elements of the terrain, weather conditions, temperature, or other aspects of the environment. In another example, sensor(s) 112 may capture data corresponding to one or more characteristics of a target or identified object, such as a size, shape, profile, structure, or orientation of the object.

Further, robotic system 100 may include sensor(s) 112 configured to receive information indicative of the state of robotic system 100, including sensor(s) 112 that may monitor the state of the various components of robotic system 100. Sensor(s) 112 may measure activity of systems of robotic system 100 and receive information based on the operation of the various features of robotic system 100, such as the operation of an extendable arm, an end effector, or other mechanical or electrical features of robotic system 100. The data provided by sensor(s) 112 may enable control system 118 to determine errors in operation as well as monitor overall operation of components of robotic system 100.

As an example, robotic system 100 may use force/torque sensors to measure load on various components of robotic system 100. In some implementations, robotic system 100 may include one or more force/torque sensors on an arm or end effector to measure the load on the actuators that move one or more members of the arm or end effector. In some examples, the robotic system 100 may include a force/torque sensor at or near the wrist or end effector, but not at or near other joints of a robotic arm. In further examples, robotic system 100 may use one or more position sensors to sense the position of the actuators of the robotic system. For instance, such position sensors may sense states of extension, retraction, positioning, or rotation of the actuators on an arm or end effector.

As another example, sensor(s) 112 may include one or more velocity or acceleration sensors. For instance, sensor(s) 112 may include an inertial measurement unit (IMU). The IMU may sense velocity and acceleration in the world frame, with respect to the gravity vector. The velocity and acceleration sensed by the IMU may then be translated to that of robotic system 100 based on the location of the IMU in robotic system 100 and the kinematics of robotic system 100.

Robotic system 100 may include other types of sensors not explicitly discussed herein. Additionally or alternatively, the robotic system may use particular sensors for purposes not enumerated herein.

Robotic system 100 may also include one or more power source(s) 114 configured to supply power to various components of robotic system 100. Among other possible power systems, robotic system 100 may include a hydraulic system, electrical system, batteries, or other types of power systems. As an example illustration, robotic system 100 may include one or more batteries configured to provide charge to components of robotic system 100. Some of mechanical components 110 or electrical components 116 may each connect to a different power source, may be powered by the same power source, or be powered by multiple power sources.

Any type of power source may be used to power robotic system 100, such as electrical power or a gasoline engine. Additionally or alternatively, robotic system 100 may include a hydraulic system configured to provide power to mechanical components 110 using fluid power. Components of robotic system 100 may operate based on hydraulic fluid being transmitted throughout the hydraulic system to various hydraulic motors and hydraulic cylinders, for example. The hydraulic system may transfer hydraulic power by way of pressurized hydraulic fluid through tubes, flexible hoses, or other links between components of robotic system 100. Power source(s) 114 may charge using various types of charging, such as wired connections to an outside power source, wireless charging, combustion, or other examples.

Electrical components 116 may include various mechanisms capable of processing, transferring, or providing electrical charge or electric signals. Among possible examples, electrical components 116 may include electrical wires, circuitry, or wireless communication transmitters and receivers to enable operations of robotic system 100. Electrical components 116 may interwork with mechanical components 110 to enable robotic system 100 to perform various operations. Electrical components 116 may be configured to provide power from power source(s) 114 to the various mechanical components 110, for example. Further, robotic system 100 may include electric motors. Other examples of electrical components 116 may exist as well.

Robotic system 100 may include a body, which may connect to or house appendages and components of the robotic system. As such, the structure of the body may vary within examples and may further depend on particular operations that a given robot may have been designed to perform. For example, a robot developed to carry heavy loads may have a wide body that enables placement of the load. Similarly, a robot designed to operate in tight spaces may have a relatively tall, narrow body. Further, the body or the other components may be developed using various types of materials, such as metals or plastics. Within other examples, a robot may have a body with a different structure or made of various types of materials.

The body or the other components may include or carry sensor(s) 112. These sensors may be positioned in various locations on the robotic system 100, such as on a body, a head, a neck, a base, a torso, an arm, or an end effector, among other examples.

Robotic system 100 may be configured to carry a load, such as a type of cargo that is to be transported. In some examples, the load may be placed by the robotic system 100 into a bin or other container attached to the robotic system 100. The load may also represent external batteries or other types of power sources (e.g., solar panels) that the robotic system 100 may utilize. Carrying the load represents one example use for which the robotic system 100 may be configured, but the robotic system 100 may be configured to perform other operations as well.

As noted above, robotic system 100 may include various types of appendages, wheels, end effectors, gripping devices and so on. In some examples, robotic system 100 may include a mobile base with wheels, treads, or some other form of locomotion. Additionally, robotic system 100 may include a robotic arm or some other form of robotic manipulator. In the case of a mobile base, the base may be considered as one of mechanical components 110 and may include wheels, powered by one or more of actuators, which allow for mobility of a robotic arm in addition to the rest of the body.

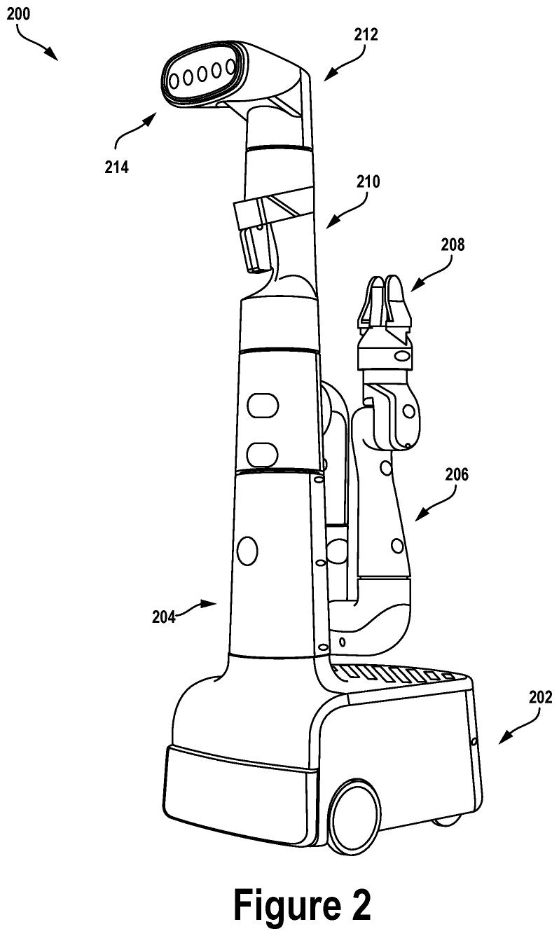

FIG. 2 illustrates a mobile robot, in accordance with example embodiments.

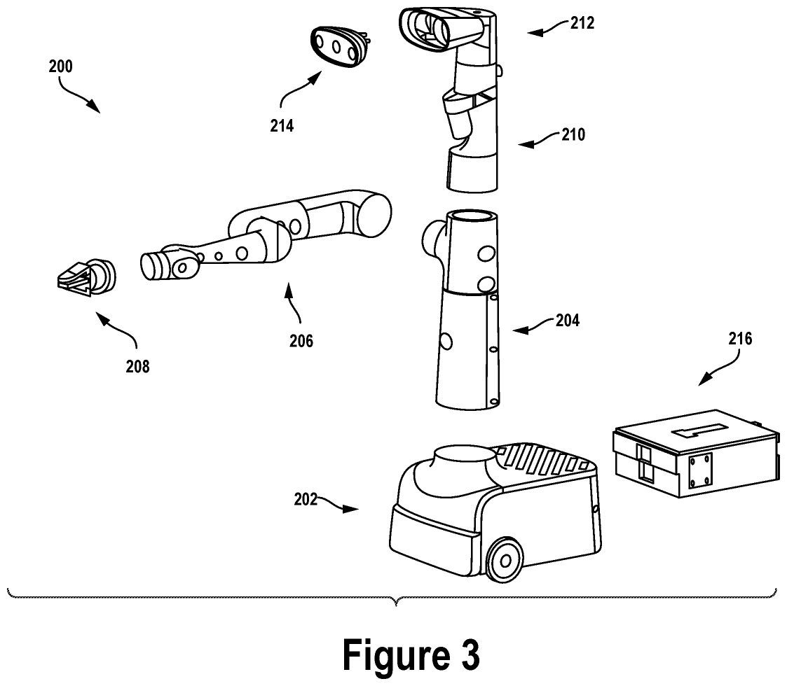

FIG. 3 illustrates an exploded view of the mobile robot, in accordance with example embodiments. More specifically, robot 200 may include mobile base 202, midsection 204, arm 206, end-of-arm system (EOAS) 208, mast 210, perception housing 212, and perception suite 214. Robot 200 may also include compute box 216 stored within mobile base 202.

Mobile base 202 includes two drive wheels positioned at a front end of robot 200 in order to provide locomotion to robot 200. Mobile base 202 also includes additional casters (not shown) to facilitate motion of mobile base 202 over a ground surface. Mobile base 202 may have a modular architecture that allows compute box 216 to be easily removed. Compute box 216 may serve as a removable control system for robot 200 (rather than a mechanically integrated control system). After removing external shells, compute box 216 can be easily removed and/or replaced. Mobile base 202 may also be designed to allow for additional modularity. For example, mobile base 202 may also be designed so that a power system, a battery, and/or external bumpers can all be easily removed and/or replaced.

Midsection 204 may be attached to mobile base 202 at a front end of mobile base 202. Midsection 204 includes a mounting column which is fixed to mobile base 202. Midsection 204 additionally includes a rotational joint for arm 206. More specifically, Midsection 204 includes the first two degrees of freedom for arm 206 (a shoulder yaw J0 joint and a shoulder pitch J1 joint). The mounting column and the shoulder yaw J0 joint may form a portion of a stacked tower at the front of mobile base 202. The mounting column and the shoulder yaw J0 joint may be coaxial. The length of the mounting column of midsection 204 may be chosen to provide arm 206 with sufficient height to perform manipulation tasks at commonly encountered height levels (e.g., coffee table top and/or counter top levels). The length of the mounting column of midsection 204 may also allow the shoulder pitch J1 joint to rotate arm 206 over mobile base 202 without contacting mobile base 202.

Arm 206 may be a 7DOF robotic arm when connected to midsection 204. As noted, the first two DOFs of arm 206 may be included in midsection 204. The remaining five DOFs may be included in a standalone section of arm 206 as illustrated in FIGS. 2 and 3. Arm 206 may be made up of plastic monolithic link structures. Inside arm 206 may be housed standalone actuator modules, local motor drivers, and thru bore cabling.

EOAS 208 may be an end effector at the end of arm 206. EOAS 208 may allow robot 200 to manipulate objects in the environment. As shown in FIGS. 2 and 3, EOAS 208 may be a gripper, such as an underactuated pinch gripper. The gripper may include one or more contact sensors such as force/torque sensors and/or non-contact sensors such as one or more cameras to facilitate object detection and gripper control. EOAS 208 may also be a different type of gripper such as a suction gripper or a different type of tool such as a drill or a brush. EOAS 208 may also be swappable or include swappable components such as gripper digits.

Mast 210 may be a relatively long, narrow component between the shoulder yaw J0 joint for arm 206 and perception housing 212. Mast 210 may be part of the stacked tower at the front of mobile base 202. Mast 210 may be fixed relative to mobile base 202. Mast 210 may be coaxial with midsection 204. The length of mast 210 may facilitate perception by perception suite 214 of objects being manipulated by EOAS 208. Mast 210 may have a length such that when the shoulder pitch J1 joint is rotated vertically up, a topmost point of a bicep of arm 206 is approximately aligned with a top of mast 210. The length of mast 210 may then be sufficient to prevent a collision between perception housing 212 and arm 206 when the shoulder pitch J1 joint is rotated vertically up.

As shown in FIGS. 2 and 3, mast 210 may include a 3D lidar sensor configured to collect depth information about the environment. The 3D lidar sensor may be coupled to a carved-out portion of mast 210 and fixed at a downward angle. The lidar position may be optimized for localization, navigation, and for front cliff detection.

Perception housing 212 may include at least one sensor making up perception suite 214. Perception housing 212 may be connected to a pan/tilt control to allow for reorienting of perception housing 212 (e.g., to view objects being manipulated by EOAS 208). Perception housing 212 may be a part of the stacked tower fixed to mobile base 202. A rear portion of perception housing 212 may be coaxial with mast 210.

Perception suite 214 may include a suite of sensors configured to collect sensor data representative of the environment of robot 200. Perception suite 214 may include an infrared(IR)-assisted stereo depth sensor. Perception suite 214 may additionally include a wide-angled red-green-blue (RGB) camera for human-robot interaction and context information. Perception suite 214 may additionally include a high resolution RGB camera for object classification. A face light ring surrounding perception suite 214 may also be included for improved human-robot interaction and scene illumination. In some examples, perception suite 214 may also include a projector configured to project images and/or video into the environment.

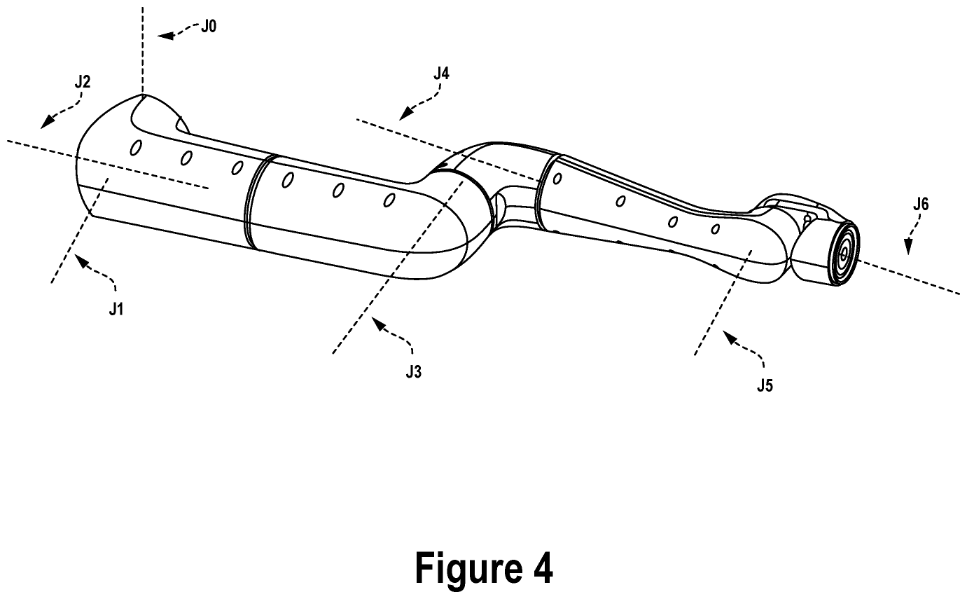

FIG. 4 illustrates a robotic arm, in accordance with example embodiments. The robotic arm includes 7 DOFs: a shoulder yaw J0 joint, a shoulder pitch J1 joint, a bicep roll J2 joint, an elbow pitch J3 joint, a forearm roll J4 joint, a wrist pitch J5 joint, and wrist roll J6 joint. Each of the joints may be coupled to one or more actuators. The actuators coupled to the joints may be operable to cause movement of links down the kinematic chain (as well as any end effector attached to the robot arm).

The shoulder yaw J0 joint allows the robot arm to rotate toward the front and toward the back of the robot. One beneficial use of this motion is to allow the robot to pick up an object in front of the robot and quickly place the object on the rear section of the robot (as well as the reverse motion). Another beneficial use of this motion is to quickly move the robot arm from a stowed configuration behind the robot to an active position in front of the robot (as well as the reverse motion).

The shoulder pitch J1 joint allows the robot to lift the robot arm (e.g., so that the bicep is up to perception suite level on the robot) and to lower the robot arm (e.g., so that the bicep is just above the mobile base). This motion is beneficial to allow the robot to efficiently perform manipulation operations (e.g., top grasps and side grasps) at different target height levels in the environment. For instance, the shoulder pitch J1 joint may be rotated to a vertical up position to allow the robot to easily manipulate objects on a table in the environment. The shoulder pitch J1 joint may be rotated to a vertical down position to allow the robot to easily manipulate objects on a ground surface in the environment.

The bicep roll J2 joint allows the robot to rotate the bicep to move the elbow and forearm relative to the bicep. This motion may be particularly beneficial for facilitating a clear view of the EOAS by the robot's perception suite. By rotating the bicep roll J2 joint, the robot may kick out the elbow and forearm to improve line of sight to an object held in a gripper of the robot.

Moving down the kinematic chain, alternating pitch and roll joints (a shoulder pitch J1 joint, a bicep roll J2 joint, an elbow pitch J3 joint, a forearm roll J4 joint, a wrist pitch J5 joint, and wrist roll J6 joint) are provided to improve the manipulability of the robotic arm. The axes of the wrist pitch J5 joint, the wrist roll J6 joint, and the forearm roll J4 joint are intersecting for reduced arm motion to reorient objects. The wrist roll J6 point is provided instead of two pitch joints in the wrist in order to improve object rotation.

### III. EXAMPLE LOGICAL ARCHITECTURE OF THE TOOL RACK

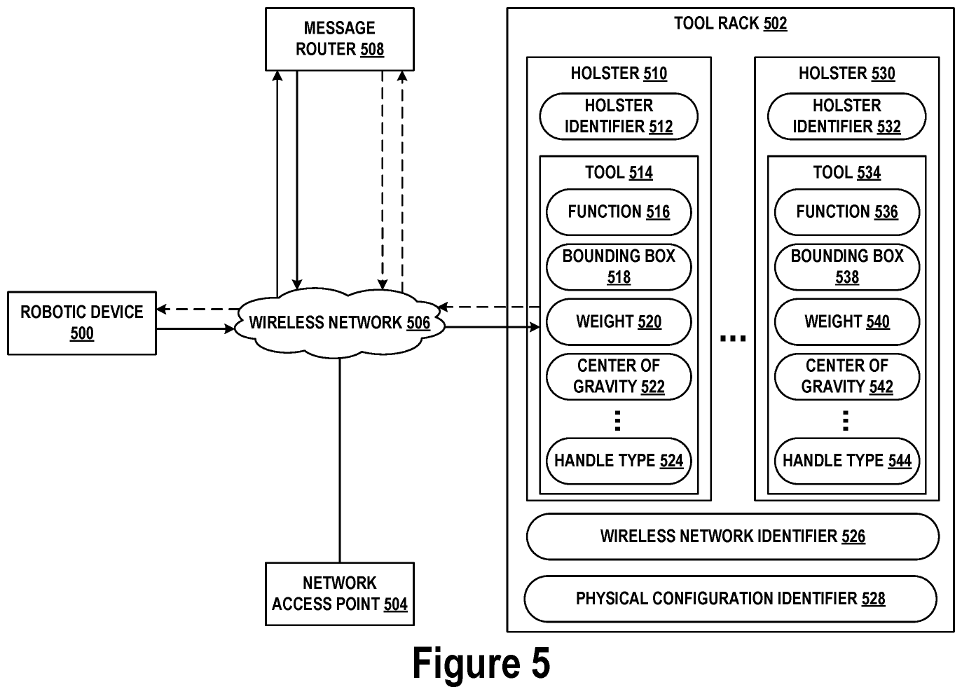

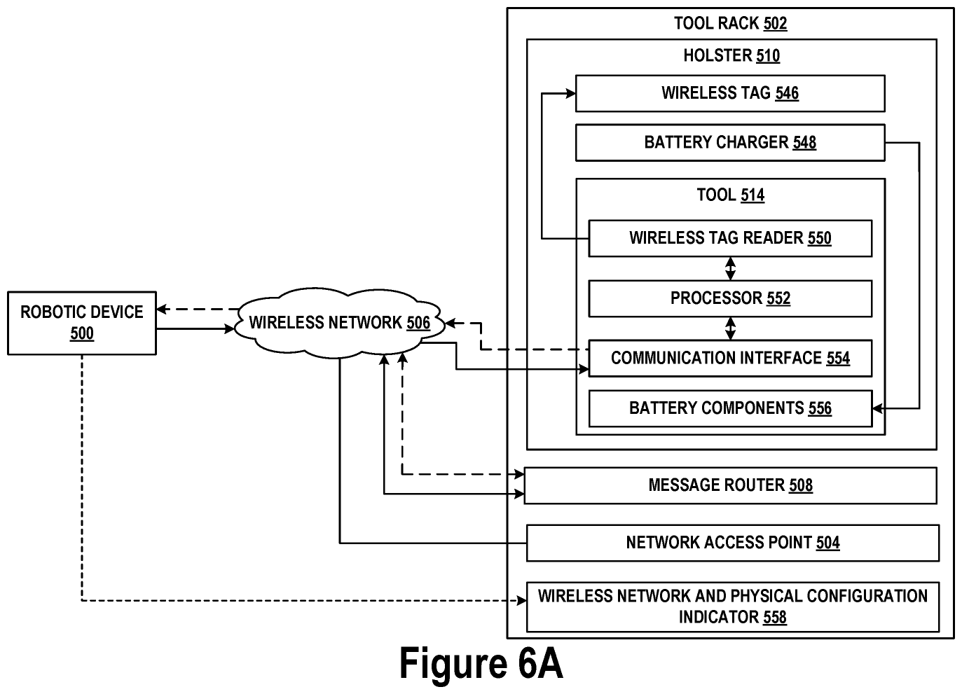

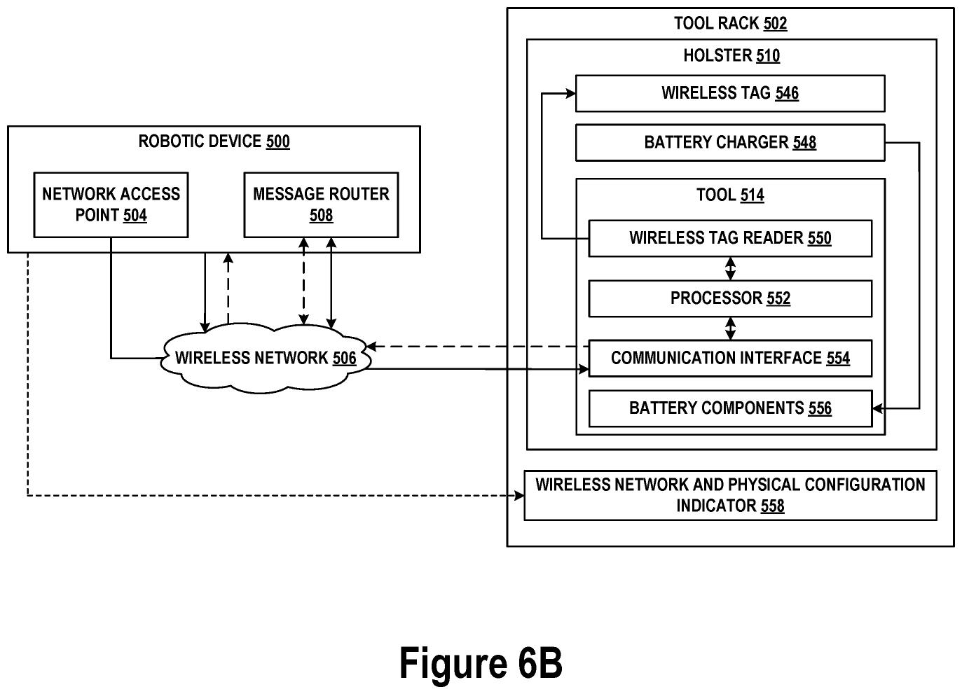

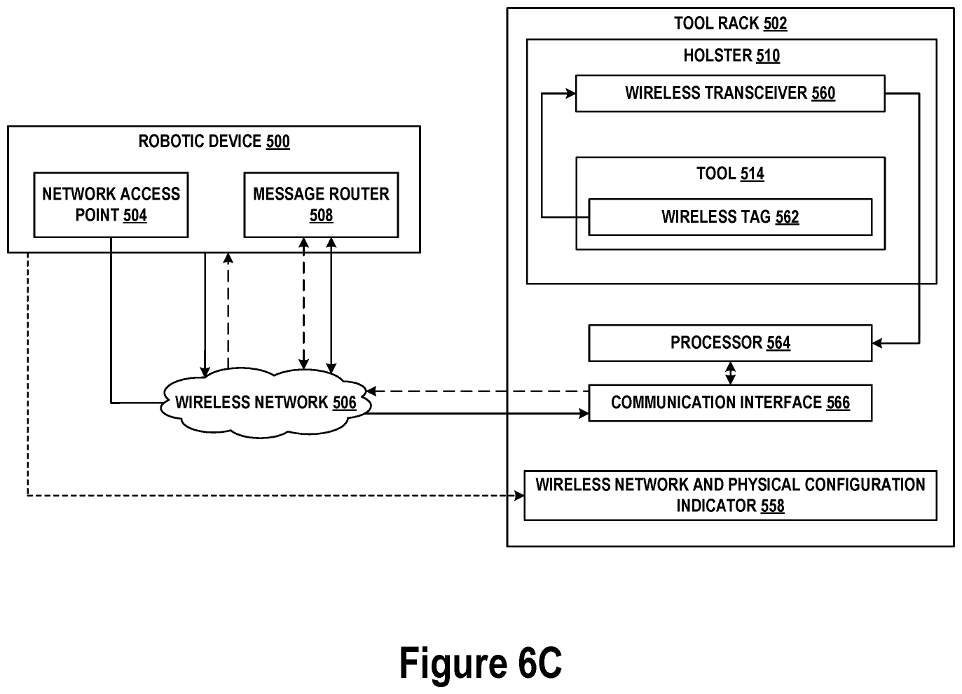

FIG. 5 illustrates an example logical arrangement of components that allow a robotic device to use various tools provided on a tool rack. Specifically, FIG. 5 shows a system that includes robotic device 500, tool rack 502, network access point 504, and message router 508. FIG. 5 illustrates the logical arrangements of these components and their respective attributes, while FIGS. 6A, 6B, and 6C illustrate example physical arrangements and/or physical structures of these components. Robotic device 500 may represent and/or include aspects of robotic system 100 and/or robot 200. Tool rack 502 may represent a mechanical structure configured to hold one or more tools that are usable by robotic device 500 to perform various tasks and/or operations. Tool rack 502 may alternatively be referred to as a tool box, a tool holder, and/or a tool stand, among other possibilities.

Tool rack 502 may include a plurality of holsters, including holster 510 through holster 530 (i.e., holsters 510-530). Each respective holster of holsters 510-530 may be configured and/or structured to provide for removable coupling/mounting of one or more tools to the respective holster. For example, holster 510 may have tool 514 coupled thereto and holster 530 may have tool 534 coupled thereto, with other holsters having other tools coupled thereto. The tools provided on tool rack 502 may collectively be referred to as tools 514-534. Placement of each of tools 514-534 may be interchangeable among each of holsters 510-530. Specifically, in some implementations, each of holsters 510-530 may share a common connector and/or mounting structure, and each of the tools used in connection with tool rack 502 may share a common adapter structure configured to removably couple to the connector and/or mounting structure. Thus, each of tools 514-534 may alternatively be placed within other ones of holsters 510-530 (e.g., tool 514 may be placed in holster 530 and tool 534 may be placed in holster 510).

Each of holsters 510-530 may be associated with a corresponding holster identifier. Specifically, holster 510 may be associated with holster identifier 512 and holster 530 may be associated with holster identifier 532. Holster identifier 512 may indicate, to tool 514 (or another tool attached to holster 510), a unique identifier of holster 510 (e.g., unique at least with respect to other holsters of tool rack 502). Tool 514 may be configured to determine holster identifier 512 and indicate, to robotic device 500, that tool 514 is located in holster 510, thereby informing robotic device 500 of how to interact with tool 514. Holster identifier 532 may facilitate similar functionality of tools located in holster 530. For example, when holsters 510-530 include three different holsters, holster identifier 512 may have a value of 1, holster identifier 532 may have a value of 3, and the holster identifier of the remaining holster may have a values of 2.

Tool rack 502 may be associated with wireless network identifier 526, which may correspond to and represent wireless network 506. Wireless network identifier 526 may be, for example, an alphanumeric string (e.g., a service set identifier (SSID)) usable by computing devices to distinguish multiple different wireless networks from one another. Wireless network 506 may be, for example, a wireless personal area network (WPAN) or a wireless local area network (WLAN) generated by network access point 504. Network access point 504 may be configured to generate wireless network 506 using one or more wireless standards, including IEEE 802.15 (e.g., ZIGBEE®, 6LoWPAN, BLUETOOTH®, BLUETOOTH® Low Energy (BLE)), International Telecommunications Union 9959 (e.g., Z-Wave), Wireless USB, IEEE 802.11 (e.g., Wi-Fi), and/or IEEE 802.16 (e.g., WiMAX) among other possibilities. Network access point 504 may be configured to generate wireless network 506 independently of whether network access point 504 is connected to and/or able to connect to another wireless network, such as the Internet.

Wireless network 506 and wireless network identifier 526 may each be reserved for and/or may be unique to tool rack 502. That is, each respective tool rack of a plurality of tool racks may be associated with a corresponding wireless network identifier and a corresponding wireless network, each of which may be unique to the respective tool rack. Wireless network identifier 526 may be configured to indicate to tools 514-534 and/or to robotic device 500 the identity of wireless network 506 by way of which these components are to communicate with one another in order to allow robotic device 500 to use tools 514-534.

Specifically, tool rack 502 may be arranged such that wireless network identifier 526 (i) is determinable by a tool when the tool is placed in a holster and (ii) is determinable by a robotic device when tool rack 502 is mounted on, connected to, and/or otherwise interfacing with the robotic device. When a tool is moved to a different tool rack, the tool may be configured to determine the wireless network identifier associated with the different tool rack and connect to the corresponding wireless network in order to be able to communicate with the robotic device that is using the different tool rack. Similarly, when a tool rack is moved to a different robot, the different robot may determine the wireless network identifier associated with the tool rack and connect to the corresponding wireless network and/or message router in order to be able to communicate with the tools provided on the tool rack. Thus, by being specific to tool rack 502, wireless network 506 may operate to define, to robotic device 500, the scope of tools (e.g., number, placement, functionality, etc.) available on tool rack 502.

Tool rack 502 may also be associated with physical configuration identifier 528, which may be configured to indicate, to robotic device 500, a physical structure of tool rack 502. Configuration identifier 528 may indicate, for example, a number of holsters 510-530 included on tool rack 502 and a position of each of holsters 510-530 relative to a reference point on tool rack 502, among other possibilities. The reference point on tool rack 502 may be, for example, a mounting point on robotic device 500 at which tool rack 502 is connected, thus indicating to robotic device 500 a position of each of holsters 510-530 in a reference frame of robotic device 500. Configuration identifier 528 may also provide a mapping between each of holster identifiers 512-532 of holsters 510-530 and each of the positions of holsters 510-530 relative to the reference point.

Each respective tool of tools 514-534 may be associated with a corresponding plurality of attributes. For example, tool 514 may be associated with function 516, bounding box 518, weight 520, center of gravity 522, and handle type 524, among other possibilities. Function 516 may indicate one or more operations that are performable by and/or using tool 514, and may thus inform robotic device 500 whether tool 514 is usable for a given task. For example, function 516 may indicate that tool 514 is an ultraviolet (UV) light emitter, an air quality sensor, a screwdriver, or a vacuum, among other possibilities. Bounding box 518 may indicate a size and/or shape of tool 514, and thus provide information for motion planning of an arm of robotic device 500. Weight 520 and center of gravity 522 may inform robotic device 500 of how tool 514 affects the mass and/or inertial properties of the arm when tool 514 is held and/or operated thereby. Handle type 524 may indicate a shape, size, and/or other physical properties of a handle attached to tool 514 by way of which tool 514 may be gripped and/or otherwise removably coupled to the arm of robotic device 500, and may thus inform robotic device 500 whether the EOAS thereof is configured to pick up tool 514. Similarly, tool 534 may be associated with function 536, bounding box 538, weight 540, center of gravity 542, and handle type 544, which indicate commensurate attributes of tool 534.

Message router 508 may be configured to route communications between robotic device 500 and tools mounted on tool rack 502. Much like wireless network 506, message router 508 may be reserved for and/or unique to tool rack 502. Thus, other tool racks may each be associated with a corresponding message router. An example transmission sequence for communications from robotic device 500 to tools 514-534 is indicated with solid lines, while another example transmission sequence for communications from tools 524-534 to robotic device 500 is indicated with dashed lines. Message router 508 may be implemented using hardware components, software components, or a combination thereof.

In some implementations, message router 508 may be accessible by way of wireless network 506, but might not be accessible by way of other wireless networks. For example, for each respective tool rack of a plurality of tool racks, the corresponding message router may be associated with a same, predetermined network address (e.g., a predetermined internet protocol (IP) address). Accordingly, communications from robotic device 500 may be transmitted to tools 514-534 on tool rack 502 (and/or vice versa), rather than to some other set of tools (e.g., on another tool rack), based on robotic device 500 being connected to and using wireless network 506 (which is specific to tool rack 502), rather than some other wireless network, to transmit these communications to the predetermined network address. In another example, each respective tool rack may be associated with a different predetermined network address for the corresponding message router, which may be indicated to robotic device 500 and/or to the tools on the respective tool rack as part of wireless network identifier 526.

Message router 508 may be based on, may include, and/or may implement Message Queuing Telemetry Transport (MQTT) protocol, Advanced Message Queuing Protocol (AMQP), Streaming Text Oriented Protocol (STOMP), Extensible Messaging and Presence Protocol (XMPP), WEAVE™, OPENWEAVE™, REDIS®, SQL SERVER® Service Broker, Web Sub, Data Distribution Service (DDS), Simple Application Messaging Protocol (SAMP), APACHE KAFKA®, and/or ZEROMQ®, among other possibilities. Depending on the implementations, message router 508 may alternatively be referred to as and/or include a message handler, a message queue, a message broker, and/or a message server, among other possibilities. In general, message router 508 may be configured to allow robotic device 500 to transmit messages to the tools on tool rack 502 (e.g., individually to particular tools, and/or by way of a broadcast to all tools), and may allow each of the tools to transmit messages to robotic device 500. In some implementations, message router 508 might not be configured to allow tools to communicate with each other, since each tool may be configured to operate independently of other tools.

### IV. EXAMPLE PHYSICAL ARCHITECTURES OF THE TOOL RACK

FIGS. 6A, 6B, and 6C illustrate example physical components and arrangements thereof configured to provide the logical architecture shown in FIG. 5. Holster 510 and tool 514 are shown as representative examples of holsters 510-530 and tools 514-534, respectively. FIGS. 6A and 6B each show holster 510 including wireless tag 546 and battery charger 548, and tool 514 including wireless tag reader 550, processor 552, communication interface 554, and battery components 556.

Wireless tag 546 may include any device(s) and/or symbol(s) configured to (i) represent wireless network identifier 526 and holster identifier 512 and (ii) be identified (e.g., read, scanned, interpreted, and/or decoded) by wireless tag reader 550 when tool 514 is coupled to holster 510. For example, wireless tag reader 550 may be placed on tool 514 such that when tool 514 is coupled to holster 510, wireless tag reader 550 is placed in proximity of and/or alignment with wireless tag 546, thus allowing wireless tag reader 550 to identify wireless tag 546. Thus, wireless tag 546 may be configured to inform tool 514 (i) that tool 514 is disposed within holster 510, rather than another holster of tool rack 502, and (ii) that tool 514 may communicate with robotic device 500 by transmitting messages to message router 508 by way of wireless network 506, rather than another wireless network.

Wireless tag 546 may include and/or be implemented as a barcode (e.g., a quick response (QR) code), printed text configured to be read using optical character recognition (OCR), a Near-Field Communication (NFC) device, magnetic storage (e.g., a magnetic stripe, such as a magstripe), a radio frequency identification (RFID) tag, and/or a BLUETOOTH® low energy (BLE) beacon, among other possibilities. Accordingly, wireless tag reader 550 may include a barcode reader, an image sensor, an NFC receiver and/or transmitter, a magnetic head, an RFID receiver and/or transmitter, and/or a BLUETOOTH® receiver and/or transmitter, among other possibilities.

Alternatively or additionally, in some implementations, the functionality provided by wireless tag 546 may instead be provided by a physical connection between tool 514 and holster 510. In one example, tool 514 and holster 510 may be electrically connected (e.g., using spring contacts) when tool 514 is placed in holster 510, and may be disconnected when tool 514 is removed from holster 510. Specifically, holster 510 may include electrical contacts configured to electrically connect with corresponding electrical contacts of tool 514 when tool 514 is coupled to holster 510, and data representing holster identifier 512 and/or wireless network identifier 526 may thus be transferred from holster 510 to tool 514 using a wired connection. In another example, holster 510 may include raised peaks and/or valleys (e.g., molded into holster 510) that mechanically encode information about holster 510 and/or tool rack 502. Tool 514 may be configured to read these peaks and/or valleys using buttons on tool 514, which may be configured to generate corresponding signals during and/or after insertion into holster 510.

Battery charger 548 may include a wireless battery charger and/or a wired battery charger configured to charge a battery of tool 514. Battery components 556 may include the battery, a battery charger adapter (e.g., a wireless charger receiver or a wired plug), and circuitry configured to manage charging and discharging of the battery. Processor 552 may be similar to and/or include aspects of processor(s) 102 discussed with respect to FIG. 1. Processor 552 may be configured to control operations of tool 514 and facilitate communications between tool 514 and robotic device 500. Communication interface 554 may be configured to communicate with message router 508 by way of wireless network 506. Thus, the specific implementation of communication interface 554 may depend on the specific implementation of wireless network 506.

Wireless network and physical configuration indicator 558 may include any device(s) and/or symbol(s) configured to (i) encode wireless network identifier 526 and physical configuration identifier 528 and (ii) be identified (e.g., read, scanned, interpreted, and/or decoded) by, for example, a wireless tag reader of robotic device 500 when tool rack 502 is coupled to, mounted on, and/or otherwise physically interfacing with robotic device 500. Thus, wireless network and physical configuration indicator 558 may be implemented in the same or similar manner as wireless tag 546 discussed above. In some implementations, the wireless network indicator may be separate from the physical configuration indicator.

In the arrangement shown in FIG. 6A, message router 508 and network access point 504 are each physically provided as part of tool rack 502, rather than as part of robotic device 500. For example, the hardware components that define and/or provide message router 508 and/or network access point 504 may be physically integrated with, physically connected to, and/or physically mounted on tool rack 502. Thus, the same network access point 504 and message router 508 may be used in connection with tool rack 502 regardless of the specific robotic device that is using tool rack 502 at a given time.

For example, network access point 504 may be configured to generate wireless network 506 based on tool rack 502 being powered on (e.g., plugged in to a power adapter on robotic device 500), and may continue to generate wireless network 506 while too rack 502 remains powered. Similarly, message router 508 may be active, and thus provide a communicative connection between robotic device 500 and tools 514-534 by way of wireless network 506, while tool rack 502 is powered on.

In the arrangement shown in FIG. 6B, message router 508 and network access point 504 are each provided as part of robotic device 500, rather than as part of tool rack 502. For example, the hardware components that define and/or provide message router 508 and/or network access point 504 may be physically integrated with, physically connected to, and/or physically mounted on robotic device 500. When robotic device 500 represents robot 200, for example, message router 508 and network access point 504 may be provided as part of compute box 216. Thus, the same network access point 504 and message router 508 may be used in connection with robotic device 500 regardless of the specific tool rack that is being used by robotic device 500 at a given time. However, the specific wireless network generated by network access point 504 may change over time as different tool racks are used by robotic device 500.

For example, network access point 504 may be configured to generate wireless network 506 based on robotic device 500 scanning wireless network and physical configuration indicator 558. Message router 508 may thus be able to connect robotic device 500 to tools 514-534 on tool rack 502 by way of wireless network 506. When tool rack 502 is replaced with a different tool rack, network access point 504 may be configured to generate a different wireless network based on robotic device 500 scanning the wireless network and physical configuration indicator of the different tool rack. Message router 508 may thus be able to connect robotic device 500 to the tools provided on the different tool rack by way of the different wireless network.

In some cases, when message router 508 is provided as part of robotic device 500, robotic device 500 may be configured to communicate with message router 508 directly, that is, without the communication therebetween being transmitted by way of wireless network 506. Communications between message router 508 and tools 514-534 may continue to be transmitted by way of wireless network 506. For example, message router 508 may be provided as part of a computing device of robotic device 500, and robotic device 500 may thus communicate with message router 508 by way of communication infrastructure and/or protocols internal to robotic device 500, while tools 514-534 communicate with message router 508 by way of wireless network 506.

In some implementations, message router 508 may be provided as part of robotic device 500, while network access point 504 is provided as part of tool rack 502, or vice versa. Further, in other implementations, message router 508 and/or network access point 504 may be provided as one or more discrete components that are physically separate from robotic device 500 and tool rack 502 (e.g., as shown in FIG. 5). For example, message router 508 may be a discrete device configured to electrically connect to robotic device 500 by way of, for example, a Universal Serial Bus (USB) provided on robotic device 500. Robotic device 500 may thus be configured to communicate with message router 508 by way of the wired USB connection, rather than by way of wireless network 506, and message router 508 may use wireless network 508 to communicate with tools 514-534.

The discrete device may be associated with (e.g., may be specific and/or unique to) tool rack 502. Thus, the same network access point 504 and/or message router 508 may be used in connection with tool rack 502 regardless of the specific robotic device that is using tool rack 502 at a given time. In some implementations, the discrete device that includes message router 508 and/or network access point 504 (or another discrete device) may also include wireless network and physical configuration indicator 558, and may thus be configured to provide wireless network identifier 526 and/or physical configuration identifier 528 to robotic device 500 by way of the wired connection therewith. Accordingly, robotic device 500 may be configured to use tool rack 502 by plugging the discrete component associated therewith into a data port on robotic device 500.

FIG. 6C illustrates an alternative arrangement in which a wireless tag is provided on tool 514, rather than on holster 510, and a wireless tag reader is provided on holster 510, rather than on tool 514. Specifically, FIG. 6C shows tool rack 502 including processor 564 and communication interface 566, holster 510 including wireless transceiver 560, and tool 514 including wireless tag 562. Such an arrangement may be utilized, for example, with tools that do not include processor 552, communication interface 554, battery components 556, and/or other powered components. Such tools may be referred to as passive tools. In some implementation, network access point 504 and/or message router 508 may instead form part of tool rack 502, as shown in FIG. 5A.

Wireless transceiver 560 may be configured to read wireless tag 562 provided on tool 514. Thus, wireless transceiver 560 may be implemented using the same or similar technology as wireless tag reader 550, and wireless tag 562 may be implemented using the same or similar technology as wireless tag 546. Specifically, wireless tag transceiver 560 may be configured to read wireless tag 562 to determine one or more attributes of tool 514 and provide this information to processor 564. Processor 552 may be analogous to processor 552, but may be provided on tool rack 502 rather than on tool 514.

Thus, based on wireless transceiver 560 reading wireless tag 562, processor 564 may be configured to transmit, to robotic device 500, by way of communication interface 566 and message router 508, data indicative of attributes of tool 514. That is, when tool 514 is passive, processor 546 and communication interface 566 may perform operations that might otherwise be performed by processor 552 and communication interface 554, thereby allowing robotic device 500 to determine what tools are provided in different holsters of tool rack 502.

In some cases, the arrangement of FIG. 6C may also be used with tool 514 that includes processor 552, communication interface 554, battery components 556, and/or other powered components. In such cases, wireless transceiver 560 may additionally be configured to write, to wireless tag 562, information about holster 510 and/or tool rack 502. Whereas in the arrangements of FIGS. 6A and 6B, information about holster 510 and/or tool rack 502 was determined by tool 514 by reading wireless tag 546, in the arrangement of FIG. 6C the same information may instead be written to wireless tag 562 by wireless transceiver 560. Processor 552 of tool 514 may subsequently obtain this information by reading a memory of wireless tag 562, thus allowing tool 514 to determine wireless network and physical configuration indicator 558, among other attributes of tool tack 502.

### V. EXAMPLE IMPLEMENTATIONS OF THE TOOL RACK

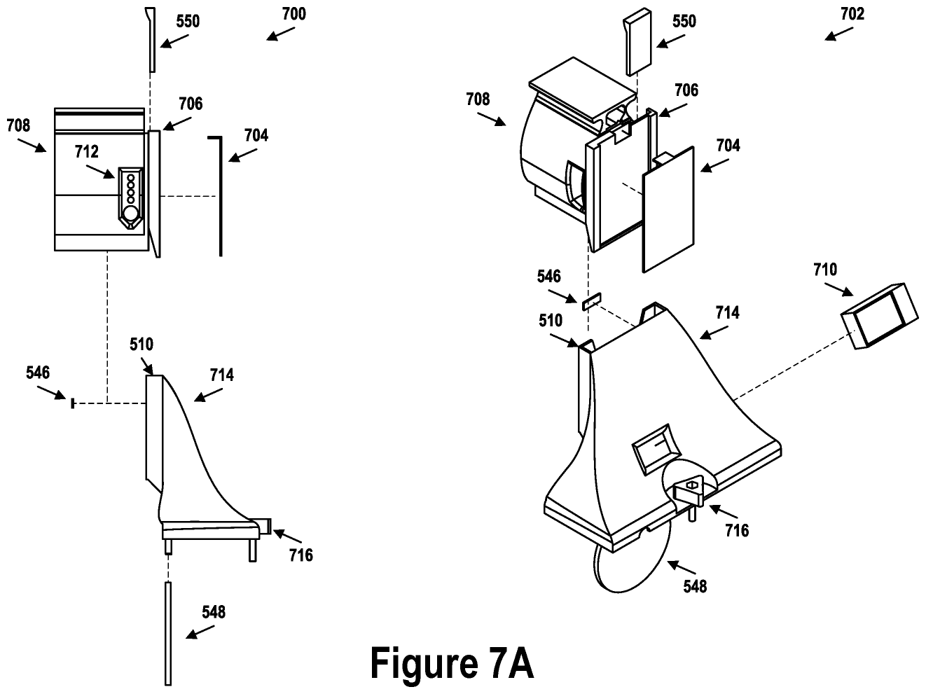

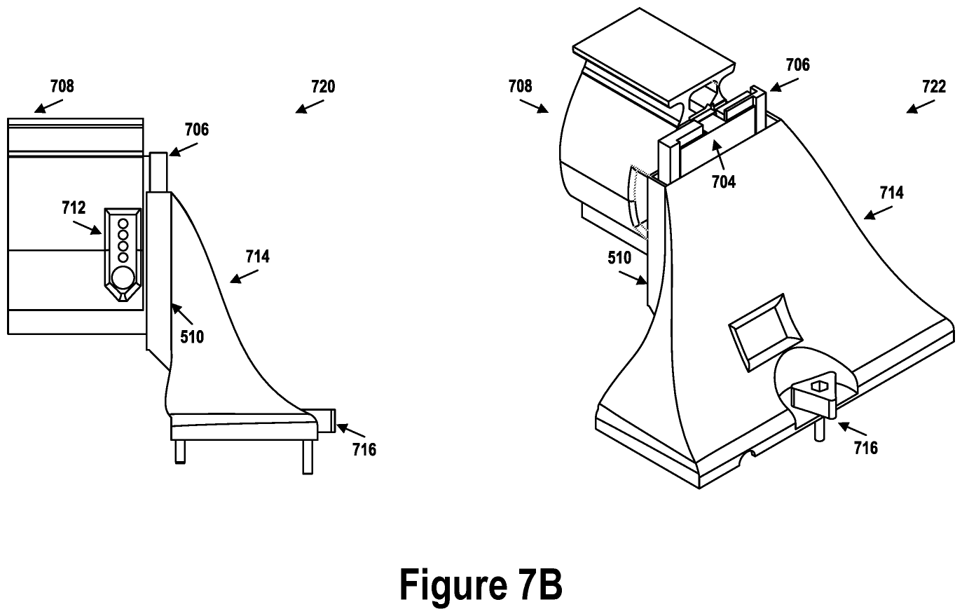

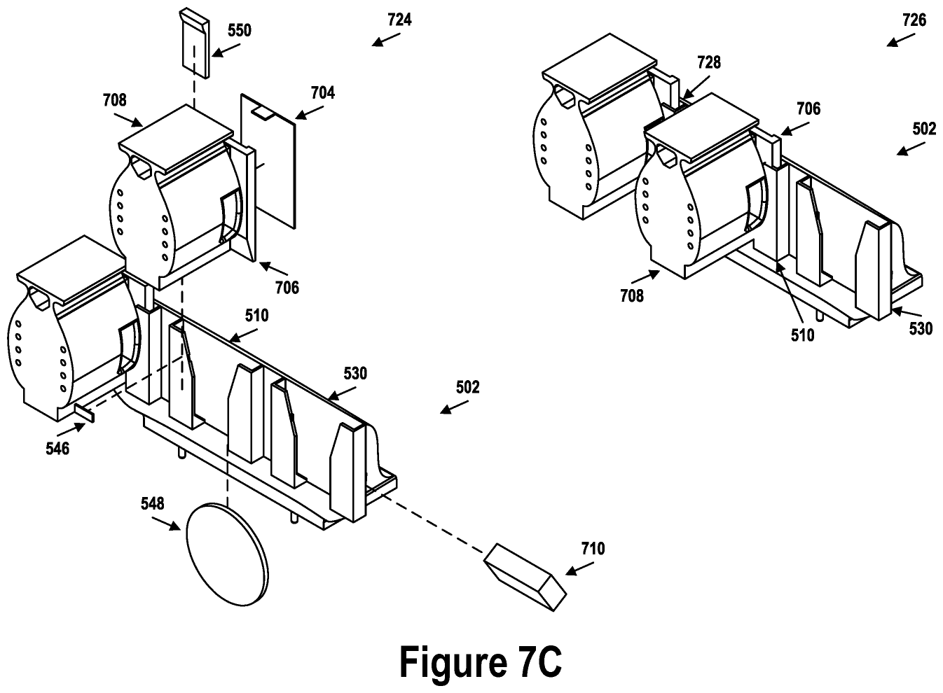

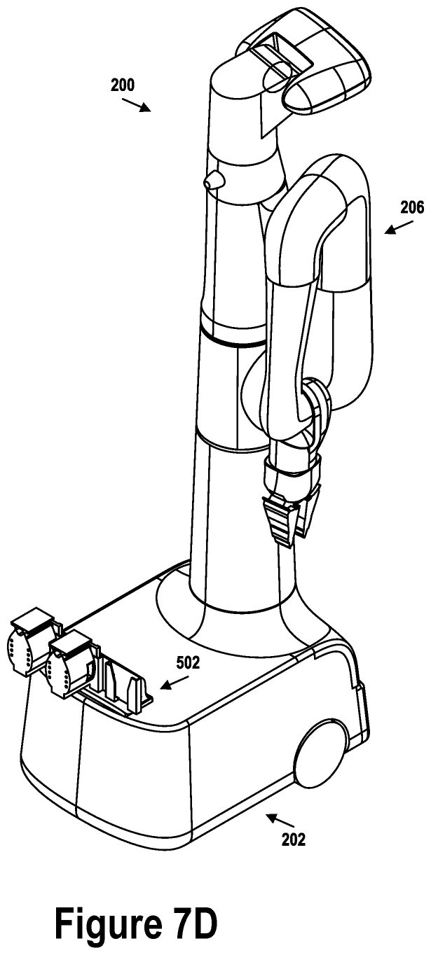

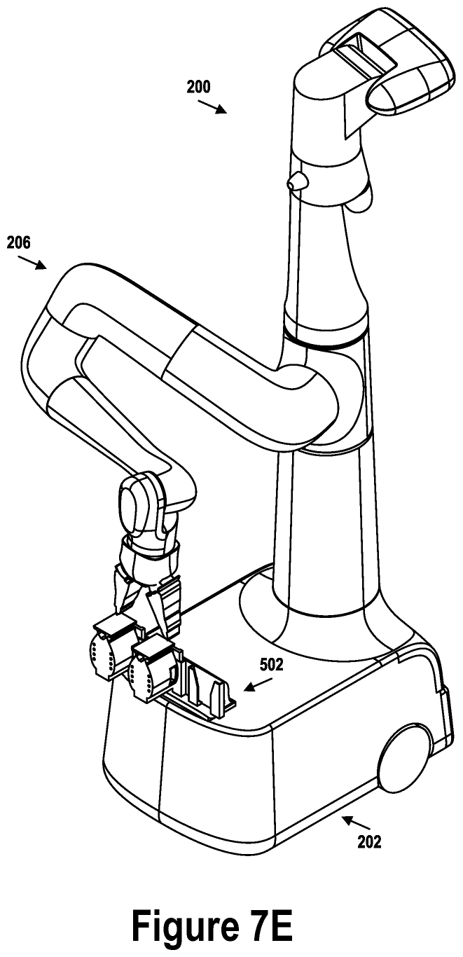

FIGS. 7A, 7B, and 7C illustrate an example physical implementation of aspects of tool rack 502 and tool 514. Specifically, FIG. 7A includes exploded side view 700 and exploded isometric view 702 of a portion 714 of tool rack 502 and portions of tool 514. FIG. 7B includes assembled side view 720 and assembled isometric view 722 corresponding to exploded side view 700 and exploded isometric view 702, respectively. FIG. 7C includes exploded isometric view 724 and assembled isometric view 726 of an implementation of tool rack 502 that has three holsters.

Tool rack portion 714 represents a physical subsection of tool rack 502. Tool rack portion 714 may be physically connected (e.g., removably or fixedly) to other portions of tool rack 502 (some of which may be the same as or similar to portion 714), thus defining an entirety of tool rack 502. Tool rack portion 714 may be removably connectable to robotic device 500 using fastener 716, which may represent and/or include a screw, a bolt, a snap, a dowel, and/or a clip, among other possibilities. Alternatively, fastener 716 may be used to removably connect tool rack portion 714 to another portion (e.g., a post, pole, column, pillar, or other structure) of tool rack 502 that is configured to connect tool rack portion 714 to robotic device 500 and position tool rack portion 714 at a predetermined position relative to robotic device 500.

Tool rack portion 714 also includes holster 510, which defines a connector configured to removably couple to adapter 706, which forms part of tool 514. Adapter 706 is mounted to handle 708, which is configured to be gripped by and/or otherwise be removably mounted to the EOAS of robotic device 500 in order to operate tool 514. In the example shown, the connector includes an approximately rectangular volume defined at least in part by fins configured to retain adapter 706 within the volume. In general, the connector defined by holster 510 and adapter 706 may represent and/or include any combination of mating physical features that allow handle 708 to be removably connected to holster 510 by way of adapter 706, including linear mechanical mating, rotational mechanical mating, magnetic coupling, pneumatic coupling, separable snap joints, quick-release mechanisms, buckles, hook and loop fasteners (e.g., VELCRO®), and/or self-mating reclosable fasteners (e.g., 3M® DUAL LOCK®), among other possibilities. In some cases, when the connector of holster 510 and adapter 706 are connected together, one or more parts thereof may undergo plastic deformation.

An active component of tool 514, such as a sensor, light emitter, cutter, sweeper, and/or other component may be connected to handle 708, but is not shown in FIGS. 7A, 7B, and 7C. For example, the active component may be disposed within a volume of handle 708, or may extend/protrude downward from handle 708, among other possibilities. The architectures and physical arrangements herein may be used in connection with a plurality of different tools irrespective of the specific active components included as part of each tool and/or functionality provided by each tool. The position and/or orientation (i.e., pose) of tool 514, including the active component thereof, may be controlled by robotic device 500 by gripping handle 708 using the EOAS and moving the arm thereof to achieve a desired pose and/or series of poses for performing a particular task.

Wireless tag 546 may be mounted inside of and/or adjacent to the volume formed by the connector of holster 510, and wireless tag reader 550 may be mounted at a corresponding position on adapter 706 and/or handle 708. Accordingly, when adapter 706 is attached to (e.g., fully engaged with) the connector of holster 510, wireless tag reader 550 may be positioned adjacent to and/or facing wireless tag 546, thus allowing wireless tag reader 550 to scan wireless tag 546. Similarly, battery charger 548 (shown as a wireless charger transmitter) may be mounted inside of and/or adjacent to the volume formed by the connector of holster 510, and wireless charger receiver 704 (forming part of battery components 556) may be mounted at a corresponding position on adapter 706 and/or handle 708. Accordingly, when adapter 706 is attached to (e.g., fully engaged with) the connector of holster 510, battery charger 548 may be positioned adjacent to and/or facing wireless charger receiver 704, thus allowing for wireless charging of tool 514 by charger 548.

Electrical components 712 of tool 514 are shown mounted on an outside surface of handle 708. Alternatively, in some cases, some or all of electrical components 712 may be mounted inside handle 708. Electrical components 712 may include processor 552, communication interface 554, parts of battery components 556, wireless tag 562, user interface components, and/or other components involved in providing the functionality of tool 514. Electrical components 710 of tool rack 502 are shown disposed inside of a volume of tool rack portion 714. Electrical component 710 may include various devices and/or circuitry involved in providing power to and/or controlling operations of wireless tag 546, wireless transceiver 560, processor 564, communication interface 566, battery charger 548, and/or other components that interact with tools connected to tool rack 502, among other possibilities. In some implementations, such as that shown in FIG. 6A, electrical component 710 may include and/or provide message router 508 and network access point 504.

FIG. 7C illustrates tool rack 502 including holsters 510, 530, and 728, each of which may be provided as part of a corresponding subsection of tool rack 502. Holsters 530 and 728, as well as the tools placed therein, may be associated with corresponding instances of the structures and components shown in FIGS. 7A and 7B. In some implementations, tool rack 502 may include more holsters than shown in FIG. 7C. FIG. 7C shows that the connectors defined by holsters 510, 530, and 728 allow for the adapters to be moved vertically to couple and decouple tools to these holsters, but do not allow for more than a threshold extent of lateral movement of the adapters to retain the tools in the holsters.

FIGS. 7D and 7E illustrate tool rack 502 attached to robot 200, which may represent robotic device 500. Specifically, FIG. 7D illustrates an arrangement of robot 200 prior to reaching for a tool in tool rack 502, while FIG. 7E illustrates an arrangement of robot 200 while reaching for a tool in tool rack 502. Tool rack 502 may be positioned at a predetermined pose on mobile base 202 of robot 200. Additionally, as discussed above, tool rack 502 may be configured to indicate, to robot 200, a physical structure of tool rack 502, including the number of holsters provided thereon and the pose of each holster relative to a reference position on tool rack 502.

Accordingly, since each of (i) the pose of tool rack 502 on mobile base 202, (ii) the pose of each holster on tool rack 502, and (iii) the pose of each tool handle relative to a corresponding holster are predetermined and/or known to robot 200, robotic device may be able to retrieve tools from tool rack 502 without relying on perception of tool rack 502. Specifically, robot 200 may be configured to determine, for each respective holster, a position of a handle of a tool disposed in the respective holster in a reference frame of robot 200 based on the predetermined and/or known poses of tool rack 502, the respective holster, and/or the handle of the tool disposed in the respective holster. Thus, robot 200 may be configured to repeatedly retrieve tools from and return tools to the respective holster by moving EOAS 208 to a predetermined set of coordinates associated with the respective holster. Accordingly, multiple different tools may be retrieved from and/or returned to the respective holster based on a single determination of tool handle position for the respective holster.

Additionally, since tools may be retrieved without relying on perception thereof, robot 200 may be able to use the perception systems thereof to perform other tasks while tools are being retrieved from and/or returned to tool rack 502. For example, while a given tool is being retrieved, the perception systems may be used to collect sensor data about the environment in preparation for performance of a task that uses the given tool. Thus, by consistently positioning tools at the predetermined coordinates, tool rack 502 may allow robot 200 greater freedom to multitask.

In some implementations, rather than being connected directly to robot 200, tool rack 502 may instead be provided as part of a workstation that is physically separate from robot 200. Robot 200 may be configured to pull up to and interact with the workstation in order to use tools provided on tool rack 502. In some cases, the workstation may include physical features configured to facilitate physical alignment between robot 200 and tool rack 502 so that each of the tools on tool rack 502 is positioned at known, predetermined coordinates relative to robot 200.

### VI. EXAMPLE OPERATIONS OF THE TOOL RACK, TOOLS, AND ROBOTIC DEVICE

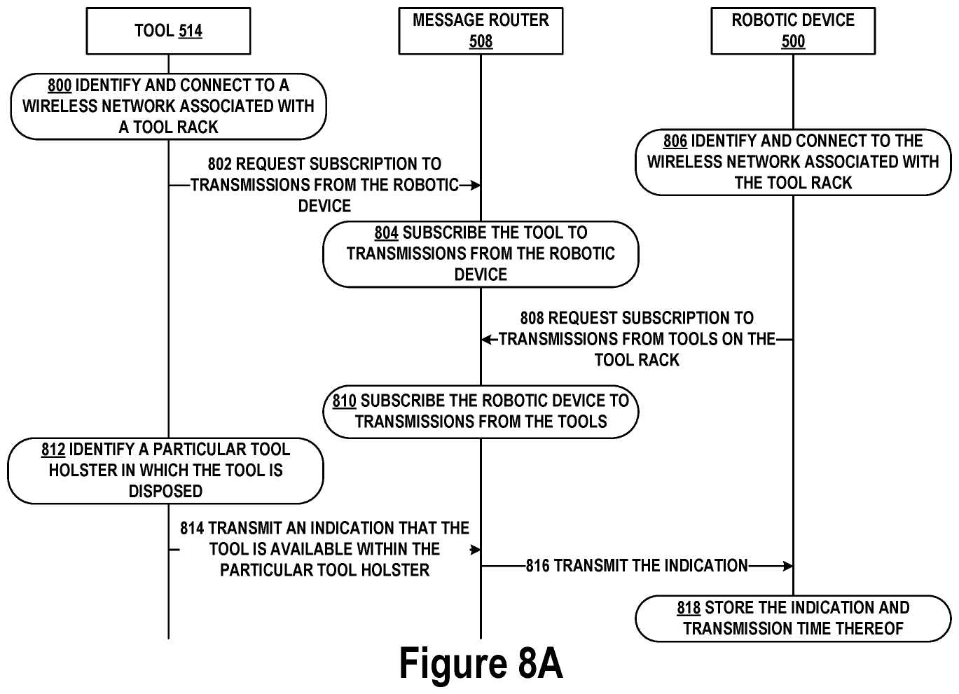

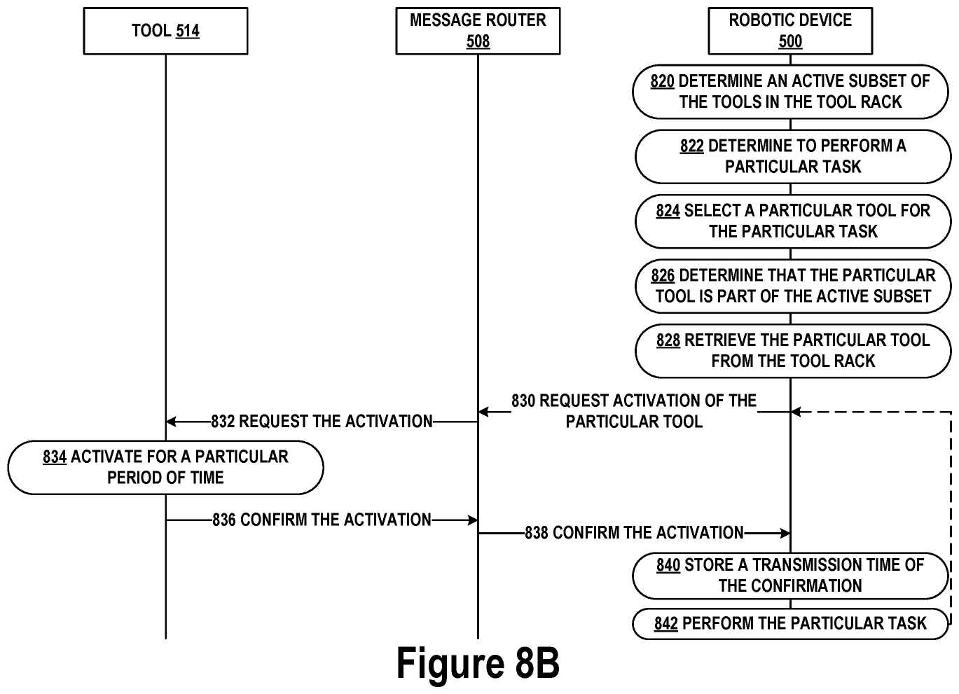

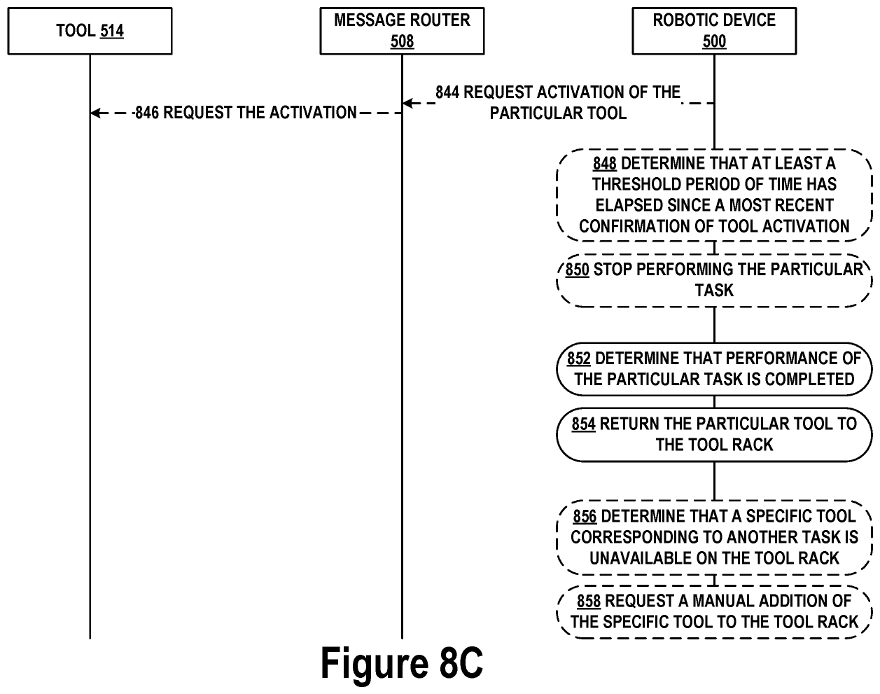

FIGS. 8A, 8B, and 8C illustrate example operations that may be performed by robotic device 500, tool 514, and message router 508 in connection with usage of tool rack 502 by robotic device 500. Tool 514 is used as a representative example of a plurality of different tools that may be used in connection with tool rack 502.

Tool 514 may be configured to identify and connect to a wireless network associated with a tool rack, as indicated by block 800. In one example in the context of tool rack 502, tool 514 may determine wireless network identifier 526 of wireless network 506 by scanning wireless tag 546 using wireless tag reader 550 based on and/or in response to being placed in holster 510. In another example in the context of tool rack 502, tool 514 may determine wireless network identifier 526 of wireless network 506 by reading data written to wireless tag 562 by wireless transceiver 560 based on and/or in response to tool 514 being placed in holster 510. Tool 514 may be configured to remain connected to wireless network 506 while tool 514 remains associated with tool rack 502, which may be determined based on periodic rescanning of wireless tag 546. For example, tool 514 may remain connected to wireless network 506 while tool 514 is being used by robotic device 500 and/or while wireless tag 546 can be rescanned, and may disconnect otherwise.

Based on and/or in response to identifying and connecting to the wireless network at block 800, tool 514 may be configured to transmit, to message router 508 and by way of wireless network 506, a request to subscribe to transmissions from robotic device 500, as indicated by arrow 802. In some implementations, the request at arrow 802 may be addressed to a predetermined network address that is (i) associated with message router 508 and (ii) shared across different tool racks. In other implementations, the request at arrow 802 may be addressed to a specific network address, defined by wireless network identifier 526, that is associated with message router 508 in the context of tool rack 502, but not in the context of other tool racks.

In some implementations, the request at arrow 802 may also indicate to message router 508 that the request is coming from a tool, rather than a robotic device, and may include an identifier associated with tool 514. Thus, the request at arrow 802 may inform message router 508 of how future transmissions from tool 514 are to be routed, as well as which transmissions from other sources are to be forwarded to tool 514. Accordingly, based on and/or in response to reception of the request at arrow 802, message router 508 may be configured to subscribe tool 514 to transmissions from robotic device 500, as indicated by block 804. In some cases, message router 508 may omit subscribing tool 514 to, or affirmatively unsubscribe tool 514 from, transmission generated by other tools, so that each tool operated independently of other tools.

Robotic device 500 may also be configured to identify and connect to the wireless network associated with the tool rack, as indicated by block 806. For example, in the context of tool rack 502, robotic device 500 may determine wireless network identifier 526 of wireless network 506 by scanning wireless network and physical configuration indicator 558 based on and/or in response to tool rack 502 being connected to, being mounted on, and/or otherwise interfacing with robotic device 500. Robotic device 500 may be configured to remain connected to wireless network 506 while robotic device 500 continues using tool rack 502.

Based on and/or in response to identifying and connecting to the wireless network at block 806, robotic device 500 may be configured to transmit, to message router 508 and possibly by way of wireless network 506, a request to subscribe to transmissions from tools on tool rack 502 (e.g., tool 514), as indicated by arrow 808. The request at arrow 802 may address message router 508 in much the same way as the request at arrow 802.

In some implementations, the request at arrow 808 may also indicate to message router 508 that the request is coming from a robotic device, rather than a tool, and may include an identifier of robotic device 500. Thus, the request at arrow 808 may inform message router 508 of how future transmissions from robotic device 500 are to be routed, as well as which transmissions from other sources are to be forwarded to robotic device 500. Accordingly, based on and/or in response to reception of the request at arrow 808, message router 508 may be configured to subscribe robotic device 500 to transmissions from the tool on tool rack 502, as indicated by block 810. In some implementations, one or more of the operations of block 806, arrow 808, and block 810 may precede one or more of the operations of block 800, arrow 802, and block 804.

Tool 514 may be configured to identify a particular tool holster in which tool 514 is disposed (i.e., to which tool 514 is removably coupled), as indicated by block 812. For example, tool 514 may be configured to determine that tool 514 is disposed in holster 510 by determining holster identifier 512 based on (i) scanning of wireless tag 546 using wireless tag reader 550 or (ii) reading data written to wireless tag 562 by wireless transceiver 560. Based on and/or in response to identifying the particular tool holster at block 812, tool 514 may be configured to transmit, to message router 508 and by way of wireless network 506, an indication that the tool is available within the particular tool holster, as indicated by arrow 814. The indication may include one or more attributes associated with tool 514, such as function 516, bounding box 518, weight 520, center of gravity 522, and/or handle type 524.

Based on and/or in response to reception of the transmission at arrow 814, message router 508 may be configured to transmit the indication to robotic device 500, as indicated by arrow 816. Message router 508 may be configured to transmit the indication to robotic device 500 based on robotic device 500 being subscribed to transmissions from tool 514.

Based on and/or in response to reception of the transmission at arrow 816, robotic device 500 may be configured to store the indication and a transmission time indicating when the transmission at arrow 816 was received, as indicated by block 818. Storage of the indication and the transmission time may allow robotic device 500 to distinguish between tools that are actively available within tool box 502 and tools that are no longer available due to, for example, malfunctions and/or manual removal from tool rack 502.

Accordingly, turning to FIG. 8B, based on respective indications of tool availability and corresponding transmission times thereof, robotic device 500 may be configured to determine an active subset of the tools associated with tool rack 502, as indicated by block 820. Specifically, a given tool may be considered active (i.e., part of the active subset) if the given tool has transmitted, to robotic device 500 and within a predetermined period of time preceding a current time, a corresponding indication that the given tool is available. Thus, in order to indicate that tool 514 is active, tool 514 may be configured to periodically repeat the operations of block 812 and arrow 814. Accordingly, the given tool may be considered inactive (i.e., not part of the active subset) once the given tool stops transmitting the corresponding indication to robotic device 500 for longer than the predetermined period of time. Thus, any event that causes tool 514 to stop performing the operations of block 812 and arrow 814 (e.g., removal of tool 514 from holster 510, disconnection of tool 514 from wireless network 506, and/or a malfunction of tool 514) may automatically result in tool 514 being removed from the active subset and thus unavailable for use by robotic device 500. Accordingly, robotic device 500 may be able to avoid attempting to use a tool that is inactive.

Robotic device 500 may be configured to determine to perform a particular task, as indicated by block 822. For example, robotic device 500 may determine to perform the particular task based on a request received from a user, a command received from a central control system, a request from another robotic device, and/or processing of sensor data representing an environment in which robotic device 500 is operating, among other possibilities. Based on and/or in response to determining to perform the particular task at block 822, robotic device 500 may be configured to select a particular tool (e.g., tool 514) for the particular task, as indicated by block 824. In one example, robotic device 500 may include a mapping that relates each respective task of a plurality of possible tasks that robotic device 500 is configured to perform to one or more corresponding tools. Thus, robotic device 500 may be configured to select the particular tool for the particular task using the mapping.

Based on and/or in response to selecting the particular tool at block 824 and/or determining the active subset at block 820, robotic device 500 may be configured to determine that the particular tool is part of the active subset, as indicated by block 826. That is, robotic device 500 may determine that the particular tool is available to be used to perform the particular task. Based on and/or in response to determining, at block 826, that the particular tool is part of the active subset, robotic device 500 may be configured to retrieve the particular tool from the tool rack, as indicated by block 828. For example, robotic device 500 may retrieve tool 514 by moving an EOAS thereof to predetermined coordinates associated with a holster in which tool 514 is disposed, resulting in EOAS interfacing with a handle of tool 514.

Based on and/or in response to retrieval of tool 514 from the tool rack, robotic device 500 may be configured to transmit, to message router 508 and possibly by way of wireless network 506, a request for activation of tool 514, as indicated by arrow 830. Based on and/or in response to reception of the transmission at arrow 830, message router 508 may be configured to forward to tool 514, by way of wireless network 506, the request for activation of tool 514, as indicated by arrow 832.

Based on and/or in response to reception of the request at arrow 832, tool 514 may be configured to activate itself for a particular period of time, as indicated by block 834. Activation of tool 514 may involve, for example, providing power to an active component of tool 514, providing instructions to the active component of tool 514, and/or receiving data from the active component of tool 514, among other possibilities. Once the predetermined period of time elapses, tool 514 may be configured to automatically deactivate itself. Activating tool 514 for a predetermined period of time, rather than for an indefinite period of time (i.e., on until tool 514 is deactivated by robotic device 500), may allow for avoidance of tool 514 being inadvertently left in an active state while it is not being used, thereby conserving battery and extending the usable life of tool 514.

Based on and/or in response to activation of tool 514 at block 834, tool 514 may be configured to transmit, to message router 508 and by way of wireless network 506, a confirmation of the activation, as indicated by arrow 836. Based on and/or in response to reception of the transmission at arrow 836, message router 508 may be configured to forward to robotic device 500, possibly by way of wireless network 506, the confirmation, as indicated by arrow 838.

Based on and/or in response to reception of the confirmation at arrow 838, robotic device 500 may be configured to store a transmission time of the confirmation, as indicated by block 840. Additionally, based on and/or in response to reception of the confirmation at arrow 838, robotic device 500 may be configured to perform the particular task using tool 514, as indicated by block 842. Since tool 514 is configured to automatically deactivate after the particular period of time, the operations of arrow 830 through block 840 may be periodically repeated to reactivate tool 514 and inform robotic device 500 that tool 514 remains operational.

Specifically, a first confirmation received from tool 514 after tool 514 has been retrieved by robotic device 500 may cause robotic device 500 to initiate (i.e., start) performance of the particular task, while subsequent confirmations may cause robotic device 500 to continue performing the particular task. Performance of the task may continue until the particular task is completed, or until tool 514 stops providing confirmations that it is active, thus indicating that tool 514 may have malfunctioned in some respect. In particular, the transmission time of a most recent confirmation received from tool 514 by way of message router 508 may be used by robotic device 500 to determine whether tool 514 is functioning correctly.

Turning to FIG. 8C, in order to continue performing the particular task, robotic device 500 may be configured to transmit, to message router 508, another request to activate tool 514, as indicated by arrow 844, which may be forwarded to tool 514 by message router 508, as indicated by arrow 846. When tool 514 malfunctions, for example, due to the battery dying, a software error, a hardware malfunction, and/or due to other possible causes, tool 514 might not transmit, in response to the request at arrow 846, a corresponding confirmation. Accordingly, robotic device 500 may be configured to determine that at least a threshold period of time has elapsed since a most recent confirmation of tool activation has been received, as indicated by block 848. The threshold period of time may be based on, for example, the particular period of time for which tool 514 remains active and an average delay between transmission of the request at arrow 830 and reception of the confirmation at arrow 838, among other factors.

Based on and/or in response to the determination at block 848, robotic device 500 may be configured to stop performing the particular task, as indicated by block 850. Conditioning performance of the particular task on periodic feedback from tool 514 may allow robotic device 500 to avoid attempting to perform a task with a tool that is not actually active. For some tasks, dependence on this periodic feedback may save the robotic device 500 hours or even days of wasted effort. For example, when tool 514 is a sensor configured to measure one or more properties related to air quality, in the absence of the above-described dependence on periodic feedback from tool 514, robotic device 500 might spend hours moving through an environment in order to measure air quality without realizing that tool 514 has malfunctioned and is not actually measuring air quality. Similarly, when tool 514 is a UV light emitter used to disinfect surfaces, in the absence of the above-described dependence on periodic feedback from tool 514, robotic device 500 might spend hours attempting to disinfect surfaces in an environment without realizing that tool 514 has malfunctioned and is not actually emitting any UV light. When continued performance of a task is based on tool 514 periodically confirming its reactivation, robotic device 500 may spend at most the threshold period of time on attempting to use an inactive tool.

Arrows 844 and 846 and blocks 848 and 850 are shown using dashed lines to indicate that this sequence of operations is associated with a malfunction of tool 514, and thus might be omitted when tool 514 has not malfunctioned. Thus, when tool 514 has malfunctioned, robotic device 500 may instead be configured to determine that performance of the particular task is completed, as indicated by block 852. Based on and/or in response to completion of the particular task at block 852, robotic device 500 may be configured to return the particular tool to the tool rack, as indicated by block 854.

In some implementations, the operations of block 854 may alternatively be executed based on and/or in response to the determination at block 850. In other implementations, when the particular task is stopped due to tool 514 failing to provide a confirmation of activation, robotic device 500 may be configured to place tool 514 at a location other than tool rack 502 (e.g., on the ground, in an area or container designated for broken tools, etc.), thus indicating to a user or operator that tool 514 is not functioning correctly and leaving holster 510 open for a new tool.

In some cases, a tool selected for a task might not be part of the active subset. Thus, robotic device 500 may be configured to determine that a specific tool corresponding to another task is unavailable on the tool rack, as indicated by block 856. For example, the specific tool may be physically absent from tool rack 502, or may be physically present on tool rack 502 but not part of the active subset (e.g., due to a tool malfunction). Thus, based on and/or in response to the determination at block 856, robotic device 500 may be configured to request a manual addition of the specific tool to the tool rack, as indicated by block 858. The request may be displayed by way of a user interface provided on robotic device 500, provided in the form of an audible utterance generated by robotic device 500, and/or transmitted to a computing device associated with a user or operator, among other possibilities.

In response, the user or operator may manually provide the specific tool to robotic device 500 by, for example, replacing another tool on tool rack 502 or adding the specific tool to an empty holster. The specific tool may be configured to automatically identify its position on tool rack 502, connect to wireless network 506, and transmit an indication that the specific tool is available within tool rack 502, as discussed above, thus making itself available to robotic device 500. Once the specific tool is manually added to tool rack 502, the specific tool may operate without further manual intervention from the user or operator, relying instead on tool rack 502 and the components associated therewith to make the specific tool available to robotic device 500.

### VII. ADDITIONAL EXAMPLE OPERATIONS

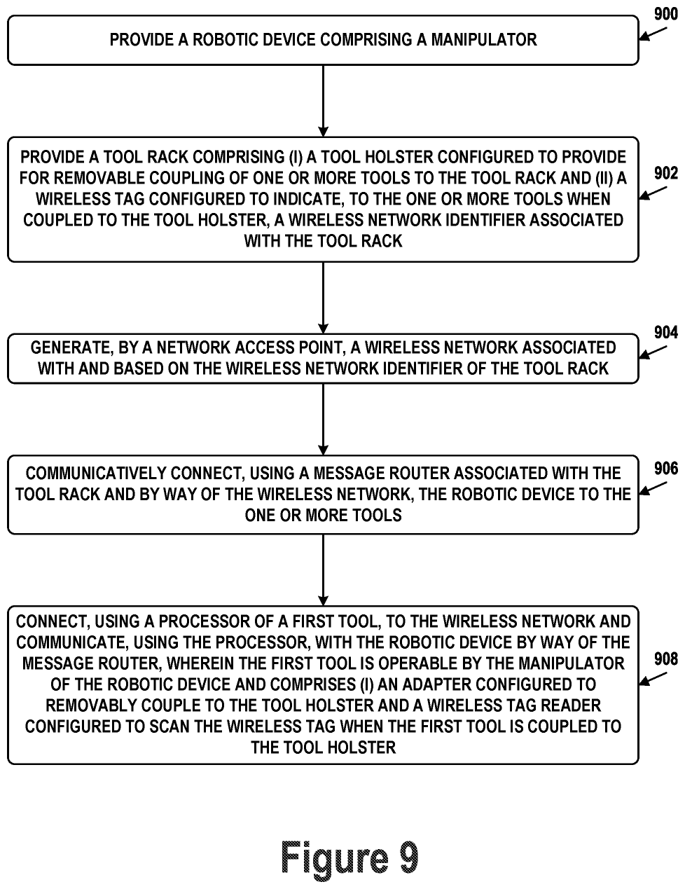

FIG. 9 illustrates a flow chart of operations related to usage of a tool rack by a robotic device. The operations may be carried out by and/or with the assistance of robotic system 100, robot 200, robotic device 500, network access point 504, message router 508, tool rack 502, and/or tools 514-534, among other possibilities. The embodiments of FIG. 9 may be simplified by the removal of any one or more of the features shown therein. Further, these embodiments may be combined with features, aspects, and/or implementations of any of the previous figures or otherwise described herein.

Block 900 may involve providing a robotic device comprising a manipulator.

Block 902 may involve providing a tool rack that includes (i) a tool holster configured to provide for removable coupling of one or more tools to the tool rack and (ii) a wireless tag configured to indicate, to the one or more tools when coupled to the tool holster, a wireless network identifier associated with the tool rack.

Block 904 may involve generating, by a network access point, a wireless network associated with and based on the wireless network identifier of the tool rack.

Block 906 may involve communicatively connecting, using a message router associated with the tool rack and by way of the wireless network, the robotic device to the one or more tools.

Block 908 may involve connecting, using a processor of a first tool, to the wireless network and communicating, using the processor, with the robotic device by way of the message router. The first tool may be operable by the manipulator of the robotic device and may include (i) an adapter configured to removably couple to the tool holster and a wireless tag reader configured to scan the wireless tag when the first tool is coupled to the tool holster.

In some embodiments, the processor may be configured to perform operations, including receiving, from the wireless tag reader, data stored by the wireless tag and, based on the data stored by the wireless tag, identifying and connecting to the wireless network and the message router. The operations may also include transmitting, to the message router and by way of the wireless network, an indication that the first tool is available within the tool holster. The message router may be configured to provide the indication to the robotic device. The operations may additionally include, based on transmitting the indication, receiving, from the message router and by way of the wireless network, a command from the robotic device.

In some embodiments, the indication that the first tool is available within the tool holster may include identification of one or more attributes associated with the first tool. The one or more attributes associated with the first tool may include one or more of: (i) a functionality provided by the first tool, (ii) a bounding box associated with the first tool, (iii) a weight of the first tool, (iv) a center of gravity of the first tool, or (v) a type of handle to which the first tool is connected.

In some embodiments, the tool rack may be connected to the robotic device at a predetermined location on the robotic device. The tool rack may further include a physical configuration indicator configured to indicate a position of the tool holster on the tool rack. The robotic device may be configured to determine a position of the tool holster in a reference frame of the robotic device based on (i) the predetermined location on the robotic device at which the tool rack is connected and (ii) the position of the tool holster on the tool rack indicated by the physical configuration identifier.

In some embodiments, the tool holster may include a plurality of tool holsters each configured to provide for removable coupling of the one or more tools to the tool rack at a corresponding predetermined position on the tool rack. The wireless tag may include a plurality of wireless tags. Each respective wireless tag of the plurality of wireless tags may be associated with a corresponding tool holster of the plurality of tool holsters and may be configured to indicate, to the one or more tools when coupled to the respective tool holster, a holster identifier of the respective holster. The processor may be configured to perform operations, including receiving, from the wireless tag reader, data stored by a particular wireless tag of the plurality of wireless tags. The operations may also include, based on the data stored by the particular wireless tag, determining a particular tool holster associated with the particular wireless tag. The operations may further include transmitting, to the message router and by way of the wireless network, an indication that the first tool is available within the particular tool holster. The message router may be configured to provide the indication to the robotic device.

In some embodiments, the first tool may include a plurality of tools. Each respective tool of the plurality of tools may be operable by the manipulator of the robotic device and may include (i) a corresponding adapter configured to removably couple to each of the plurality of tool holsters, (ii) a corresponding wireless tag reader configured to scan each of the plurality of wireless tags, (iii) a corresponding processor configured to connect to the wireless network and communicate with the robotic device by way of the message router, and (iv) a corresponding handle configured to be positioned at a predetermined position relative to each respective tool holster when the respective tool is coupled to the respective tool holster.

In some embodiments, the robotic device may be configured to retrieve the first tool from the tool holster using the manipulator and perform a corresponding task using the first tool. The first tool may be configured to automatically deactivate after a particular period of time. The processor may be configured to perform operations, including periodically receiving, from the message router and by way of the wireless network, an instruction to activate the first tool. The instruction may be based on a request to activate the first tool transmitted by the robotic device to the message router by way of the wireless network after retrieval of the first tool from the tool holster. The operations may also include, in response to receiving at least one request to activate the first tool, activating the first tool for the particular period of time. The operations may additionally include, in response to activating the first tool, transmitting, to the message router and by way of the wireless network, a confirmation that the first tool has been activated for the particular period of time.

In some embodiments, the robotic device may be configured to perform operations, including initiating performance of the corresponding task in response to receiving, from the message router and by way of the wireless network, a first confirmation that the first tool has been activated following retrieval of the first tool from the tool holster. The operations may also include continuing performance of the corresponding task in response to receiving, from the message router and by way of the wireless network, one or more additional confirmations that the first tool has been activated subsequent to the first confirmation.

In some embodiments, the robotic device may be configured to perform operations, including determining that at least a threshold period of time has elapsed since reception, from the message router and by way of the wireless network, of a most recent confirmation that the first tool has been activated, and stopping performance of the corresponding task in response to determining that at least the threshold period of time has elapsed since reception of the most recent confirmation.

In some embodiments, the network access point may be provided by and may form part of the robotic device. The tool rack may also include a wireless network indicator configured to indicate, to the robotic device, the wireless network identifier associated with the tool rack. The robotic device may be configured to generate the wireless network using the network access point based on scanning the wireless network indicator.

In some embodiments, the network access point may be provided by and may form part of the tool rack. The tool rack may also include a wireless network indicator configured to indicate, to the robotic device, the wireless network identifier associated with the tool rack. The robotic device may be configured to connect to the wireless network based on scanning the wireless network indicator.

In some embodiments, the network access point and the message router may each be provided by and form part of a discrete component that is (i) physically separate from the robotic device and the tool rack, (ii) associated with the tool rack, and (iii) configured to be electrically connected to the robotic device. The robotic device may be configured to communicate with the message router by way of an electrical connection to the discrete component. The robotic device may thus connect directly to the message router without relying on the network access point, although the message router may still utilize the network access point to communicate with the tools.

In some embodiments, the first tool may include a plurality of tools. The message router may be configured to perform operations, including subscribing each respective tool of the plurality of tools to transmissions from the robotic device, unsubscribing each respective tool from transmission by other tools of the plurality of tools, and subscribing the robotic device to transmissions from each respective tool.

In some embodiments, the first tool may include a plurality of tools. The robotic device may be configured to perform operations, including storing, for each respective tool of the plurality of tools, a corresponding time of a most recent transmission received from the message router and indicating that the respective tool is available within the tool holster. The operations may also include identifying, based on the corresponding time of the most recent transmission stored for each respective tool, an active subset of the plurality of tools, where each given tool of the active subset may be associated with a corresponding time within a predetermined period prior to a current time. The operations may additionally include determining, based on the active subset of the plurality of tools, whether a particular tool corresponding to a particular task is available on the tool rack.

In some embodiments, the robotic device may be configured to perform operations, including determining a particular task to be performed by the robotic device, determining that a particular tool corresponding to the particular task is not available on the tool rack, and, based on determining that the particular tool is not available on the tool rack, generating a request for a manual addition of the particular tool to the tool rack.

In some embodiments, the first tool may also include a sensor. The processor may be configured to perform operations, including obtaining sensor data from the sensor and transmitting, to the message router and by way of the wireless network, the sensor data. The message router may be configured to provide the sensor data to the robotic device. The robotic device may be configured to perform a corresponding task involving the sensor data.

In some embodiments, the tool rack may also include a battery charger configured to charge respective batteries of the one or more tools when the one or more tools are coupled to the tool holster. The first tool may also include (i) a battery and (ii) a battery charger adapter configured to receive electrical power from the battery charger when the first tool is coupled to the tool holster and charge the battery.

In some embodiments, a second tool operable by the manipulator of the robotic device may include (i) a second adapter configured to removably couple to tool holsters of the tool rack and (ii) a second wireless tag (e.g., wireless tag 562) configured to indicate at least one attribute associated with the second tool. A second tool holster of the tool rack may be configured to provide for removable coupling of the one or more tools to the tool rack. The second tool holster may include (i) a second wireless tag reader (e.g., wireless transceiver 560) configured to read the second wireless tag to determine the at least one attribute associated with the second tool and (ii) a second processor (e.g., processor 564) configured to connect to the wireless network and provide the at least one attribute to the robotic device by way of the message router.

In some embodiments, the second wireless tag reader may include a wireless tag transceiver. The second processor may be configured to provide the wireless network identifier to the second tool by writing, using the wireless tag transceiver, the wireless network identifier to a memory of the second wireless tag. A third processor of the second tool may be configured to determine the wireless network identifier by reading the wireless network identifier from the memory of the second wireless tag.

In some embodiments, the third processor of the second tool may be configured to connect to the wireless network based on the wireless network identifier as read from the memory of the second wireless tag. The second tool may also be configured to communicate, using the third processor, with the robotic device by way of the message router.

### VIII. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
a robotic device comprising a manipulator;
a tool rack comprising (i) a tool holster configured to provide for removable coupling of one or more tools to the tool rack and (ii) a wireless tag configured to indicate, to the one or more tools when coupled to the tool holster, a wireless network identifier associated with the tool rack;
a network access point configured to generate a wireless network associated with and based on the wireless network identifier of the tool rack;
a message router associated with the tool rack and configured to communicatively connect, by way of the wireless network, the robotic device to the one or more tools; and
a first tool operable by the manipulator of the robotic device and comprising (i) an adapter configured to removably couple to the tool holster, (ii) a wireless tag reader configured to scan the wireless tag when the first tool is coupled to the tool holster, and (iii) a processor configured to connect to the wireless network and communicate with the robotic device by way of the message router.

2. The system of claim 1, wherein the processor is configured to perform operations comprising:
receiving, from the wireless tag reader, data stored by the wireless tag;
based on the data stored by the wireless tag, identifying and connecting to the wireless network and the message router;
transmitting, to the message router and by way of the wireless network, an indication that the first tool is available within the tool holster, wherein the message router is configured to provide the indication to the robotic device; and
based on transmitting the indication, receiving, from the message router and by way of the wireless network, a command from the robotic device.

3. The system of claim 2, wherein the indication that the first tool is available within the tool holster comprises identification of one or more attributes associated with the first tool, wherein the one or more attributes comprise one or more of: (i) a functionality provided by the first tool, (ii) a bounding box associated with the first tool, (iii) a weight of the first tool, (iv) a center of gravity of the first tool, or (v) a type of handle to which the first tool is connected.

4. The system of claim 1, wherein:
the tool rack is connected to the robotic device at a predetermined location on the robotic device;
the tool rack further comprises a physical configuration indicator configured to indicate a position of the tool holster on the tool rack; and
the robotic device is configured to determine a position of the tool holster in a reference frame of the robotic device based on (i) the predetermined location on the robotic device at which the tool rack is connected and (ii) the position of the tool holster on the tool rack indicated by the physical configuration identifier.

5. The system of claim 1, wherein:
the tool holster comprises a plurality of tool holsters each configured to provide for removable coupling of the one or more tools to the tool rack at a corresponding predetermined position on the tool rack;
the wireless tag comprises a plurality of wireless tags, wherein each respective wireless tag of the plurality of wireless tags is associated with a corresponding tool holster of the plurality of tool holsters and configured to indicate, to the one or more tools when coupled to the respective tool holster, a holster identifier of the respective holster; and
the processor is configured to perform operations comprising:
receiving, from the wireless tag reader, data stored by a particular wireless tag of the plurality of wireless tags;
based on the data stored by the particular wireless tag, determining a particular tool holster associated with the particular wireless tag; and
transmitting, to the message router and by way of the wireless network, an indication that the first tool is available within the particular tool holster, wherein the message router is configured to provide the indication to the robotic device.

6. The system of claim 5, wherein the first tool comprises a plurality of tools, wherein each respective tool of the plurality of tools is operable by the manipulator of the robotic device and comprises (i) a corresponding adapter configured to removably couple to each of the plurality of tool holsters, (ii) a corresponding wireless tag reader configured to scan each of the plurality of wireless tags, (iii) a corresponding processor configured to connect to the wireless network and communicate with the robotic device by way of the message router, and (iv) a corresponding handle configured to be positioned at a predetermined position relative to each respective tool holster when the respective tool is coupled to the respective tool holster

7. The system of claim 1, wherein:
the robotic device is configured to retrieve the first tool from the tool holster using the manipulator and perform a corresponding task using the first tool;
the first tool is configured to automatically deactivate after a particular period of time; and
the processor is configured to perform operations comprising:
periodically receiving, from the message router and by way of the wireless network, an instruction to activate the first tool, wherein the instruction is based on a request to activate the first tool transmitted by the robotic device to the message router by way of the wireless network after retrieval of the first tool from the tool holster;
in response to receiving at least one request to activate the first tool, activating the first tool for the particular period of time; and
in response to activating the first tool, transmitting, to the message router and by way of the wireless network, a confirmation that the first tool has been activated for the particular period of time.

8. The system of claim 7, wherein the robotic device is configured to perform operations comprising:
initiating performance of the corresponding task in response to receiving, from the message router and by way of the wireless network, a first confirmation that the first tool has been activated following retrieval of the first tool from the tool holster; and
continuing performance of the corresponding task in response to receiving, from the message router and by way of the wireless network, one or more additional confirmations that the first tool has been activated subsequent to the first confirmation.

9. The system of claim 7, wherein the robotic device is configured to perform operations comprising:
determining that at least a threshold period of time has elapsed since reception, from the message router and by way of the wireless network, of a most recent confirmation that the first tool has been activated; and
stopping performance of the corresponding task in response to determining that at least the threshold period of time has elapsed since reception of the most recent confirmation.

10. The system of claim 1, wherein the network access point is provided by and forms part of the robotic device, wherein the tool rack further comprises a wireless network indicator configured to indicate, to the robotic device, the wireless network identifier associated with the tool rack, and wherein the robotic device is configured to generate the wireless network using the network access point based on scanning the wireless network indicator.

11. The system of claim 1, wherein the network access point is provided by and forms part of the tool rack, wherein the tool rack further comprises a wireless network indicator configured to indicate, to the robotic device, the wireless network identifier associated with the tool rack, and wherein the robotic device is configured to connect to the wireless network based on scanning the wireless network indicator.

12. The system of claim 1, wherein the network access point and the message router are each provided by and form part of a discrete component that is (i) physically separate from the robotic device and the tool rack, (ii) associated with the tool rack, and (iii) configured to be electrically connected to the robotic device, wherein the robotic device is configured to communicate with the message router by way of an electrical connection to the discrete component.

13. The system of claim 1, wherein the first tool comprises a plurality of tools, and wherein the message router is configured to perform operations comprising:
subscribing each respective tool of the plurality of tools to transmissions from the robotic device;
unsubscribing each respective tool from transmission by other tools of the plurality of tools; and
subscribing the robotic device to transmissions from each respective tool.

14. The system of claim 1, wherein the first tool comprises a plurality of tools, and wherein the robotic device is configured to perform operations comprising:
storing, for each respective tool of the plurality of tools, a corresponding time of a most recent transmission received from the message router and indicating that the respective tool is available within the tool holster;
identifying, based on the corresponding time of the most recent transmission stored for each respective tool, an active subset of the plurality of tools, wherein each given tool of the active subset is associated with a corresponding time within a predetermined period prior to a current time; and
determining, based on the active subset of the plurality of tools, whether a particular tool corresponding to a particular task is available on the tool rack.

15. The system of claim 1, wherein the robotic device is configured to perform operations comprising:
determining a particular task to be performed by the robotic device;
determining that a particular tool corresponding to the particular task is not available on the tool rack; and
based on determining that the particular tool is not available on the tool rack, generating a request for a manual addition of the particular tool to the tool rack.

16. The system of claim 1, wherein the first tool further comprises a sensor, and wherein the processor is configured to perform operations comprising:
obtaining sensor data from the sensor; and
transmitting, to the message router and by way of the wireless network, the sensor data, wherein the message router is configured to provide the sensor data to the robotic device, and wherein the robotic device is configured to perform a corresponding task involving the sensor data.

17. The system of claim 1, wherein the tool rack further comprises a battery charger configured to charge respective batteries of the one or more tools when the one or more tools are coupled to the tool holster, and wherein the first tool further comprises (i) a battery and (ii) a battery charger adapter configured to receive electrical power from the battery charger when the first tool is coupled to the tool holster and charge the battery.

18. The system of claim 1, further comprising:
a second tool operable by the manipulator of the robotic device and comprising (i) a second adapter configured to removably couple to tool holsters of the tool rack and (ii) a second wireless tag configured to indicate at least one attribute associated with the second tool; and
a second tool holster configured to provide for removable coupling of the one or more tools to the tool rack and comprising (i) a second wireless tag reader configured to read the second wireless tag to determine the at least one attribute associated with the second tool and (ii) a second processor configured to connect to the wireless network and provide the at least one attribute to the robotic device by way of the message router.

19. A method comprising:
providing a robotic device comprising a manipulator;
providing a tool rack comprising (i) a tool holster configured to provide for removable coupling of one or more tools to the tool rack and (ii) a wireless tag configured to indicate, to the one or more tools when coupled to the tool holster, a wireless network identifier associated with the tool rack;
generating, by a network access point, a wireless network associated with and based on the wireless network identifier of the tool rack, wherein the robotic device is configured to connect to the wireless network;
communicatively connecting, using a message router associated with the tool rack and by way of the wireless network, the robotic device to the one or more tools; and
connecting, using a processor of a first tool, to the wireless network and communicating, using the processor, with the robotic device by way of the message router, wherein the first tool is operable by the manipulator of the robotic device and comprises (i) an adapter configured to removably couple to the tool holster and a wireless tag reader configured to scan the wireless tag when the first tool is coupled to the tool holster.

20. A system comprising:
a robotic device comprising a manipulator;
a tool rack comprising (i) a tool holding means configured to provide for removable coupling of one or more tools to the tool rack and (ii) a wireless indicator means configured to indicate, to the one or more tools when coupled to the tool holding means, a wireless network identifier associated with the tool rack;
a network access means configured to generate a wireless network associated with and based on the wireless network identifier of the tool rack, wherein the robotic device is configured to connect to the wireless network;
a message routing means associated with the tool rack and configured to communicatively connect, by way of the wireless network, the robotic device to the one or more tools; and
a first tool operable by the manipulator of the robotic device and comprising (i) an adapter means configured to removably couple to the tool holding means, (ii) a wireless indicator reading means configured to scan the wireless indicator means when the first tool is coupled to the tool holding means, and (iii) a processor configured to connect to the wireless network and communicate with the robotic device by way of the message routing means.
